(19) United States
(12) Patent Application Publication
(10) Pub. No.: US 2024/0114586 A1
(43) Pub. Date: Apr. 4, 2024

(54) HANDLING COMMUNICATION ERRORS DURING EARLY DATA COMMUNICATION

(71) Applicant: GOOGLE LLC, Mountain View, CA (US)

(72) Inventor: Chih-Hsiang Wu, Taoyuan City (TW)

(21) Appl. No.: 18/285,261

(22) PCT Filed: Mar. 30, 2022
(86) PCT No.: PCT/US22/22463

§ 371 Date: Oct. 1, 2023

Related U.S. Application Data
(60) Provisional application No. 63/169,561, filed on Apr. 1, 2021.

(51) Int. Cl. H04W 76/27; H04W 76/19

(52) U.S. Cl. CPC H04W 76/27; H04W 76/19

(57) ABSTRACT

A central unit (CU) of a distributed base station a radio access network (RAN) can implement a method for handling communication errors when communicating with a user equipment (UE) while a radio resource control connection between the UE and the distributed base station is not active. The method includes performing (902) early data communication with a UE. The method further includes determining (904) to stop the early data communication, and, in response to the determining, transmitting (906), to the UE via a distributed unit (DU) of the distributed base station, a message to instruct the UE to stop the early data communication, the message formatted in accordance with a protocol for controlling radio resources.

### FIELD OF THE DISCLOSURE

This disclosure relates generally to wireless communications and, more particularly, to stopping early data communication at a user equipment (UE) and/or radio access network (RAN) when the UE operates in an inactive or idle state associated with a protocol for controlling radio resources.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, a base station operating a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer.

The RRC sublayer specifies the RRC_IDLE state, in which a UE does not have an active radio connection with a base station; the RRC_CONNECTED state, in which the UE has an active radio connection with the base station; and the RRC_INACTIVE to allow a UE to more quickly transition back to the RRC_CONNECTED state due to Radio Access Network (RAN)-level base station coordination and RAN-paging procedures. In some cases, the UE in the RRC_IDLE or RRC_INACTIVE state has only one, relatively small packet to transmit. In these cases, the UE is in the RRC_IDLE or RRC_INACTIVE state can perform an early data transmission without transitioning to the RRC_CONNECTED state, e.g., by using techniques as specified in section 7.3 in 3GPP specification 36.300 v16.4.0.

However, implementing early data communication (also referred to as small data transmission or small data communication) techniques present several challenges. For example, during early data communication, a UE or a network node may detect an error associated with the early data communication. However, it is not clear how the network and/or the UE should proceed after detecting the error.

### SUMMARY

Network nodes of a RAN and/or a UE can use the techniques of this disclosure to handle communication errors that occur during early data communication while the UE operates in the inactive state, where “early data communication” may include uplink early data transmission (EDT) and/or downlink EDT.

A base station, or a central unit (CU) of the base station, performing early data communication with the UE may determine to stop the early data communication. In some implementations, the base station determines to stop the early data communication in response to detecting a failure associated with the early data communication. Detecting the failure may include: detecting a security error (e.g., an integrity check error) associated with uplink data received from the UE during the early data communication, detecting that a number of attempted transmissions of data to the UE exceeds a threshold, detecting that a block error rate (BLER) exceeds a threshold, or detecting that a timer associated with the early data communication has expired. If the base station is a distributed base station, detecting the failure may include receiving, at the CU, a failure indication from a distributed unit (DU). In other implementations, the base station determines to stop the early data communication because there is no additional uplink or downlink data to communicate with the UE.

In response to determining to stop the early data communication, the base station transmits an RRC message to the UE. In some implementations, the RRC message is a connection reject message (e.g., an RRCReject message). In other implementations, the RRC message is a connection setup message (e.g., an RRCSetup message), which causes the UE to transition to the connected state. In still other implementations, the RRC message is a connection release message (e.g., an RRCRelease message). The type of RRC message that the base station transmits may vary based on the reason that the base station determined to stop the early data communication. In particular, in some implementations, if the base station determined to stop the early data communication in response to detecting a failure, then the base station transmits a connection reject message. Otherwise, the base station transmits a connection release message.

Turning to the UE, in response to receiving a connection reject message from the RAN, the UE can stop the early data communication. Further, the UE can process any available uplink data, including any uplink data that was not successfully transmitted during the early data communication, at the UE in view of the connection reject message. Accordingly, in response to receiving the connection reject message, the UE may re-initiate early data communication in order to transmit the available uplink data. Alternatively, the UE may transmit a connection setup request (e.g., an RRCSetupRequest message) to the RAN in order to transition to the connected state to transmit the available uplink data.

In some implementations, instead of receiving a connection reject message from the RAN, the UE may detect, at the UE, a failure associated with the early data communication. More particularly, the UE may detect a failure associated with communicating subsequent data packets during early data communication. Detecting the failure may include detecting a security error, determining that a number of attempted transmissions of uplink data exceeds a threshold, determining that a timer associated with the early data communication exceeds a threshold, or determining that a condition of a radio link is not suitable for early data communication (e.g., based on a BLER measurement or a signal measurement). In response to detecting the failure, the UE can stop the early data communication and process any available uplink data (e.g., by re-initiating early data communication or transitioning to the connected state).

One example embodiment of these techniques is a method implemented in a central unit (CU) of a distributed base station of a radio access network (RAN) for handling communication errors when communicating with a user equipment (UE) while a radio resource control connection between the UE and the distributed base station is not active. The method can be executed by processing hardware and includes performing early data communication with a UE. The method further includes determining to stop the early data communication, and, in response to the determining, transmitting, to the UE via a distributed unit (DU) of the distributed base station, a message to instruct the UE to stop the early data communication, the message formatted in accordance with a protocol for controlling radio resources.

Another example embodiment of these techniques is a method implemented in a base station of a RAN for handling communication errors when communicating with a UE while a radio resource control connection between the UE and the base station is not active. The method can be executed by processing hardware and includes performing early data communication with the UE and determining to stop the early data communication. The method also includes: in a first instance, if the determining is in response to detecting a failure associated with the early data communication, transmitting, to the UE, a command to reject the radio resource control connection; and, in a second instance, if the determining is not in response to detecting the failure, transmitting, to the UE, a command to release the radio resource control connection.

Yet another example embodiment of these techniques is network node of a RAN including processing hardware and configured to implement the methods above.

A further example embodiment of these techniques is a method implemented in a UE for handling communication errors when communicating with a RAN while a radio resource control connection between the UE and the RAN is not active. The method can be executed by processing hardware and includes performing early data communication with the RAN, including communicating at least a portion of a first data packet with the RAN. The method further includes detecting a trigger event corresponding to: (i) a command from the RAN to reject the radio resource control connection; or (ii) a failure associated with communicating a second data packet with the RAN during the early data communication. The method also includes, in response to detecting the trigger event: stopping the early data communication, and processing uplink data for the RAN.

A yet further example embodiment of these techniques is a UE including processing hardware and configured to implement the method above.

### BRIEF DESCRIPTION OF THE DRAWINGS

FIG. 1A is a block diagram of an example wireless communication system in which a user equipment (UE) and a base station of this disclosure can implement the techniques of this disclosure for handling communication errors during early data communication;

FIG. 1B is a block diagram of an example base station including a central unit (CU) and a distributed unit (DU) that can operate in the system of FIG. 1A;

FIG. 2A is a block diagram of an example protocol stack according to which the UE of FIG. 1A communicates with base stations;

FIG. 2B is a block diagram of an example protocol stack according to which the UE of FIG. 1A communicates with a CU and a DU;

FIG. 3A is an example message sequence in which a UE performs early data communication to transmit an uplink (UL) data packet to a base station, and a CU of the base station transmits a radio resource control (RRC) reject message to the UE in response to determining to stop the early data communication;

FIG. 3B is an example message sequence similar to the message sequence of FIG. 3A, but where the DU assembles segments of the UL data packet during the early data communication;

FIG. 3C is an example message sequence similar to the message sequence of FIG. 3B, but where the DU transmits an UL RRC message to the CU before completing assembly of the UL data packet;

FIG. 3D is an example message sequence similar to the message sequence of FIG. 3A, but where the UE determines that the base station failed to receive the UL data packet in response to receiving the RRC reject message;

FIG. 3E is an example message sequence in which a CU of a base station detects a failure during early data communication with a UE and, in response, transitions the UE to the connected state;

FIG. 3F is an example message sequence in which a UE detects a failure during early data communication with a base station and, in response, stops early data communication and transitions to the connected state;

FIG. 3G is an example message sequence in which a UE detects that a radio condition with a base station is not suitable for early data communication and, in response, stops early data communication and transitions to the connected state;

FIG. 4A is a flow diagram of an example method for stopping early data communication after receiving an RRC reject message, which can be implemented by a UE;

FIG. 4B is a flow diagram of an example method similar to the method of FIG. 4A, but where the UE re-initiates early data communication after a barring timer indicated the RRC reject message expires;

FIG. 4C is a flow diagram of an example method similar to the method of FIG. 4A, but where the UE initiates the early data communication to receive downlink (DL) data;

FIG. 4D is a flow diagram of an example method similar to the method of FIG. 4B, but where the UE initiates the early data communication to receive DL data;

FIG. 5 is a flow diagram of an example method for transmitting an RRC reject message in response to stopping early data communication, which can be implemented by a base station or a CU of the base station;

FIG. 6 is a flow diagram of an example method for transmitting an RRC reject message in response to detecting an error during early data communication with the UE, which can be implemented by a base station or a CU of the base station;

FIG. 7 is a flow diagram of an example method for determining whether to transmit an RRC reject message or an RRC release message after determining to stop early data communication, which can be implemented by a base station or a CU of the base station;

FIG. 8A is a flow diagram of an example method for stopping early data communication in response to detecting a failure during the early data communication, which can be implemented by a UE;

FIG. 8B is a flow diagram of an example method similar to the method of FIG. 8A, but where the UE performs an RRC setup procedure after stopping the early data communication;

FIG. 8C is a flow diagram of an example method similar to the methods of FIGS. 8A-8B, but where the UE initiates the early data communication to receive DL data;

FIG. 8D is a flow diagram of an example method similar to the method of FIG. 8B, but where the UE refrains from stopping the early data communication until a timer at the UE expires;

FIG. 9 is a flow diagram of an example method for handling communication errors during early data communication, which can be implemented by a CU;

FIG. 10 is a flow diagram of another example method for handling communication errors during early data communication, which can be implemented by a base station; and

FIG. 11 is a flow diagram of an example method for handling communication errors during early data communication, which can be implemented by a UE.

### DETAILED DESCRIPTION OF THE DRAWINGS

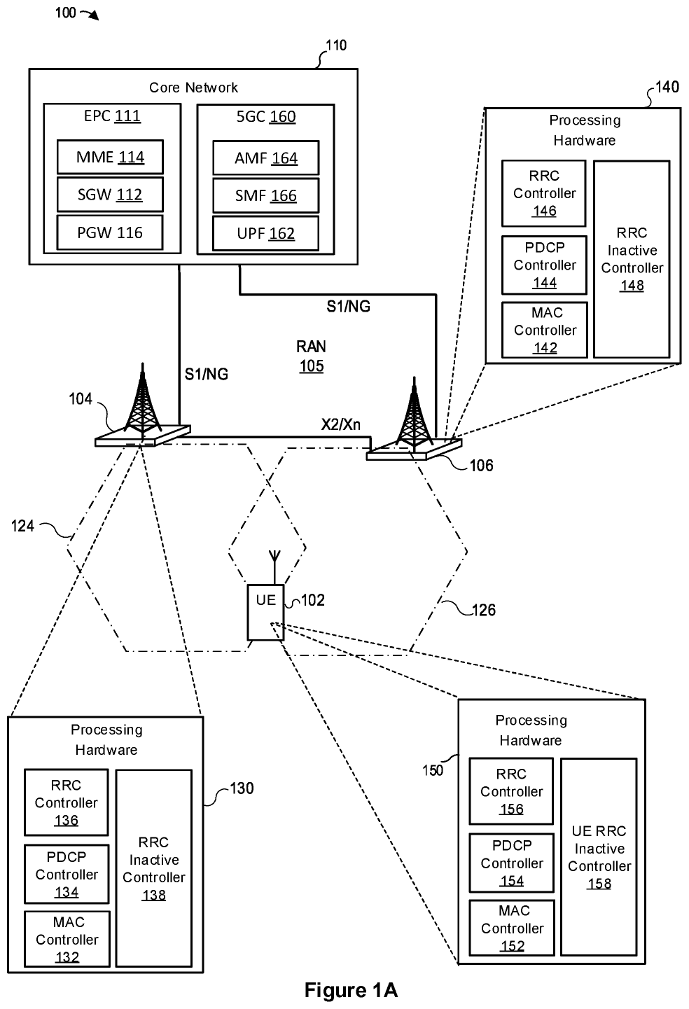

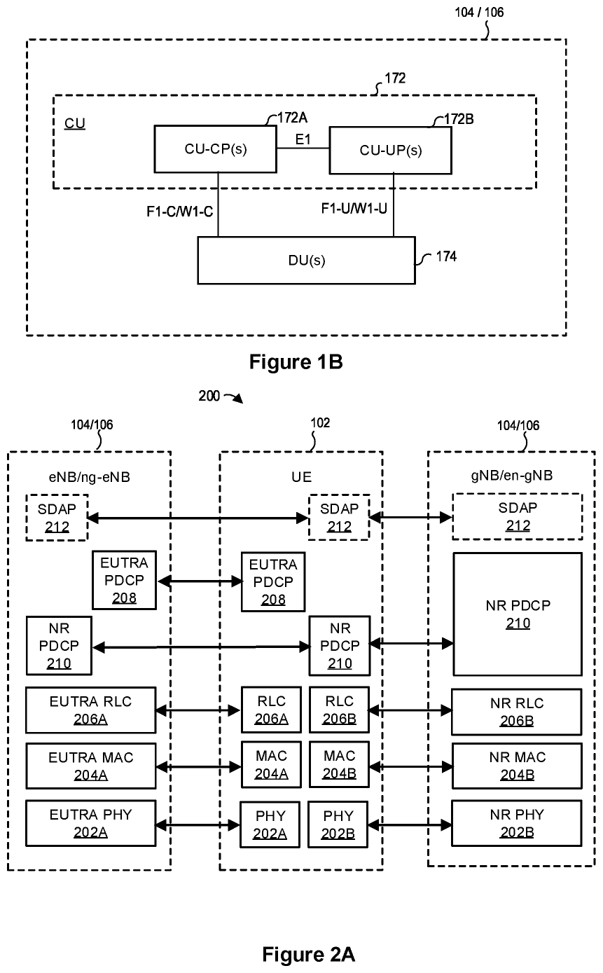

Referring first to FIG. 1A, an example wireless communication system 100 includes a UE 102, a base station (BS) 104, a base station 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core in another example.

The base station 104 covers a cell 124, and the base station 106 covers a cell 126. If the base station 104 is a gNB, the cell 124 is an NR cell. If the base station 124 is an ng-eNB, the cell 124 is an evolved universal terrestrial radio access (E-UTRA) cell. Similarly, if the base station 106 is a gNB, the cell 126 is an NR cell, and if the base station 126 is an ng-eNB, the cell 126 is an E-UTRA cell. The cells 124 and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NW”) or E-UTRA air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports a cell 124, and the base station 106 supports a cell 126. The cells 124 and 126 can partially overlap, so that the UE 102 can select, reselect, or hand over from one of the cells 124 and 126 to the other. To directly exchange messages or information, the base station 104 and base station 106 can support an X2 or Xn interface. In general, the CN 110 can connect to any suitable number of base stations supporting NR cells and/or EUTRA cells.

As discussed in detail below, the UE 102 and/or the RAN 105 can implement the techniques of this disclosure for handling communication errors when a radio resource control connection between the UE 102 and the RAN 105 is not active, e.g., in the inactive or idle state of the protocol for controlling radio resources between the UE 102 and the RAN 105. For clarity, the examples below refer to the RRC_INACTIVE or RRC_IDLE state of the RRC protocol.

As used in this disclosure, the term “data” or “data packet” refers to signaling, control-plane information at a protocol layer of controlling radio resources (e.g., RRC), controlling mobility management (MM), controlling session management (SM), or refers to non-signaling, non-control-plane information at protocol layers above the layer of the protocol for controlling radio resources (e.g., RRC), above the layer of the protocol for controlling mobility management (MM), above the layer of the protocol for controlling session management (SM), or above the layer of the protocol for controlling quality of service (QoS) flows (e.g., service data adaptation protocol (SDAP)). The data to which the UE and/or the RAN applies the techniques of this disclosure can include for example Internet of things (IoT) data, Ethernet traffic data, Internet traffic data, or a short message service (SMS) message. Further, as discussed below, the UE 102 in some implementations applies these techniques only if the size of the data is below a certain threshold value.

In the example scenarios discussed below, the UE 102 transitions to the RRC_INACTIVE or RRC_IDLE state, then selects a cell of the base station 104, and exchanges data with the base station 104 either via the base station 106 or with the base station 104 directly, without transitioning to RRC_CONNECTED state. As a more specific example, after the UE 102 determines that data is available for uplink transmission in the RRC_INACTIVE or RRC_IDLE state, the UE 102 can apply one or more security functions to the UL data packet, generate a first UL protocol data unit (PDU) including the security-protected packet, include an uplink (UL) RRC message along with the first UL PDU in a second UL PDU, and transmit the second UL PDU to the RAN 105. The UE 102 includes a UE identity/identifier (ID) of the UE 102 in the UL RRC message. The RAN 105 can identify the UE 102 based on the UE ID. In some implementations, the UE ID can be an inactive Radio Network Temporary Identifier (I-RNTI), a resume ID, or a non-access stratum (NAS) ID. The NAS ID can be an S-Temporary Mobile Subscriber Identity (S-TMSI) or a Global Unique Temporary Identifier (GUTI).

The security function can include an integrity protection and/or encryption function. When integrity protection is enabled, the UE 102 can generate a message authentication code for integrity (MAC-I) to protect integrity of the data. Thus, the UE 102 in this case generates a security-protected packet including the data and the MAC-I. When encryption is enabled, the UE 102 can encrypt the data to obtain an encrypted packet, so that the security-protected packet includes encrypted data. When both integrity protection and encryption are enabled, the UE 102 can generate a MAC-I for protecting integrity of the data and encrypt the data along with the MAC-I to generate an encrypted packet and an encrypted MAC-I. The UE 102 then can transmit the security-protected packet to the RAN 105 while in the RRC_INACTIVE or RRC_IDLE state.

In some implementations, the data is an uplink (UL) service data unit (SDU) of the packet data convergence protocol (PDCP) or SDAP. The UE 102 applies the security function to the SDU and includes the secured SDU in a first UL PDU (e.g., a UL PDCP PDU). The UE 102 then includes the UL PDCP PDU in a second UL PDU, such as a UL MAC PDU, which can be associated with the MAC layer. Thus, the UE 102 in these cases transmits the secured UL PDCP PDU in the UL MAC PDU. In some implementations, the UE 102 can include, in the UL MAC PDU, a UL RRC message. In other implementations, the UE 102 may omit a UL RRC message from the UL MAC PDU. In such implementations, the UE 102 may omit a UE ID of the UE 102 from the UL MAC PDU not including a UL RRC message. In yet other implementations, the UE 102 can include the UL PDCP PDU in a UL radio link control (RLC) PDU and then include the UL RLC PDU in the UL MAC PDU. In the case of including the UL RRC message in the UL MAC PDU, the UE 102 in some implementations generates an RRC MAC-I and includes the RRC MAC-I in the UL RRC message. For example, the RRC MAC-I is a resumeMAC-I field, as specified in 3GPP specification 38.331. In other implementations, the UE can obtain the RRC MAC-I from the UL RRC message with an integrity key (e.g., K_{RRCint} key), an integrity protection algorithm, and other parameters COUNT (e.g., 32-bit, 64-bit or 128-bit value), BEARER (e.g., 5-bit value) and DIRECTION (e.g., 1-bit value).

In other implementations, the data is an uplink (UL) protocol data unit (SDU) of the NAS. The UE 102 applies the security function to the SDU and includes the secured SDU in a first UL PDU, such as a NAS PDU, which can be associated with the NAS layer. For example, the NAS layer can be MM sublayer or SM sublayer of 5G, Evolved Packet System (EPS) or 6G. Then the UE 102 can include the UL NAS PDU in a second UL PDU such as a UL RRC message. Thus, the UE 102 in these cases transmits the (first) secured UL NAS PDU in the UL RRC message. In some implementations, the UE 102 can include the UL RRC message in a UL MAC PDU and transmit the UL MAC PDU to a base station (e.g., base station 104 or 106) via a cell (e.g., cell 124 or 126). In this case, the UE 102 may omit an RRC MAC-I from the UL RRC message. Alternatively, the UE 102 may include an RRC MAC-I as described above.

In some implementations, the UL RRC message described above can be a common control channel (CCCH) message, an RRC resume request message, or an RRC early data request message. The UL RRC message can include a UE ID of the UE 102 as described above.

More generally, the UE 102 can secure the data using at least one of encryption and integrity protection, include the secured data as a security-protected packet in the first UL PDU, and transmit the first UL PDU to the RAN 105 in the second UL PDU.

In some scenarios and implementations, the base station 106 can retrieve the UE ID of the UE 102 from the UL RRC message and identify the base station 104 as the destination of the data in the first UL PDU, based on the determined UE ID. In one example implementation, the base station 106 retrieves the first UL PDU from the second UL PDU and transmits the first UL PDU to the base station 104. The base station 104 then retrieves the security-protected packet from the first UL PDU, applies one or two security functions to decrypt the data and/or check the integrity protection, and transmits the data to the CN 110 (e.g., SGW 112, UPF 162, MME 114 or AMF 164) or an edge server. In some implementations, the edge server can operate within the RAN 105. More specifically, the base station 104 derives at least one security key from UE context information of the UE 102. Then the base station 104 retrieves the data from the security-protected packet by using the at least one security key and transmits the data to the CN 110 or edge server. When the security-protected packet is an encrypted packet, the base station 104 decrypts the encrypted packet to obtain the data by using the at least one security key (e.g., an (d)encryption key). If the security-protected packet is an integrity-protected packet, the integrity protected packet may include the data and the MAC-I. The base station 104 can verify whether the MAC-I is valid for the security-protected packet by using the at least one security key (e.g., an integrity key). When the base station 104 confirms that the MAC-I is valid, the base station 104 sends the data to the CN 110 or edge server. On the other hand, when the base station 104 determines that the MAC-I is invalid, the base station 104 discards the security-protected packet. Further, if the security-protected packet is both encrypted and integrity-protected, the encrypted and integrity-protected packet may include the encrypted packet along with the encrypted MAC-I. The base station 104 in this case decrypts the encrypted packet and the encrypted MAC-I to obtain the data and the MAC-I. The base station 104 then determines whether the MAC-I is valid for the data. If the base station 104 determines that the MAC-I is valid, the base station 104 retrieves the data and forwards the data to the CN 110 or edge server. However, if the base station 104 determines that the MAC-I is invalid, the base station 104 discards the packet.

In another implementation, the base station 106 retrieves the security-protected packet from the first UL PDU. The base station 106 performs a retrieve UE context procedure with the base station 104 to obtain UE context information of the UE 102 from the base station 104. The base station 106 derives at least one security key from the UE context information. Then the base station 106 retrieves the data from the security-protected packet by using the at least one security key and transmits the data to the CN 110 (e.g., UPF 162) or an edge server. When the security-protected packet is an encrypted packet, the base station 106 decrypts the encrypted packet to obtain the data by using the at least one security key (e.g., an (d)encryption key). If the security-protected packet is an integrity-protected packet, the integrity protected packet may include the data and the MAC-I. The base station 106 can verify whether the MAC-I is valid for the security-protected packet by using the at least one security key (e.g., an integrity key). When the base station 106 confirms that the MAC-I is valid, the base station 106 sends the data to the CN 110. On the other hand, when the base station 106 determines that the MAC-I is invalid, the base station 106 discards the security-protected packet. Further, if the security-protected packet is both encrypted and integrity-protected, the encrypted and integrity-protected packet may include the encrypted packet along with the encrypted MAC-I. The base station 106 in this case decrypts the encrypted packet and the encrypted MAC-I to obtain the data and the MAC-I. The base station 106 then determines whether the MAC-I is valid for the data. If the base station 106 determines that the MAC-I is valid, the base station 106 retrieves the data and forwards the data to the data CN 110. However, if the base station 106 determines that the MAC-I is invalid, the base station 106 discards the packet.

In other scenarios and implementations, the base station 104 can retrieve the UE ID of the UE 102 from the UL RRC message and identify that the base station 104 stores UE context information of the UE 102. Thus, the base station 104 retrieves the security-protected packet from the first UL PDU, retrieves the data from the security-protected packet, and sends the data to the CN 110 or edge server as described above.

Further, the RAN 105 in some cases transmits data in the downlink (DL) direction to the UE 102 operating in the RRC_INACTIVE or RRC_IDLE state.

For example, when the base station 104 determines that data is available for downlink transmission to the UE 102 currently operating in the RRC_INACTIVE or RRC_IDLE state, the base station 104 can apply at least one security function to the data to generate a security-protected packet, generate a first DL PDU including the security-protected packet, and include the first DL PDU in a second DL PDU. To secure the data, the base station 104 can apply the security function (e.g., integrity protection and/or encryption) to the data. More particularly, when integrity protection is enabled, the base station 104 generates a MAC-I for protecting integrity of the data, so that security-protected packet includes the data and the MAC-I. When encryption is enabled, the base station 104 encrypts the data to generate an encrypted packet, so that the security-protected packet is an encrypted packet. Further, when both integrity protection and encryption are enabled, the base station 104 can generate a MAC-I for protecting integrity of the data and encrypt the data along with the MAC-I to generate an encrypted packet and an encrypted MAC-I. The base station 104 in some implementations generates a first DL PDU, such as a DL PDCP PDU, using the security-protected packet, includes the first DL PDU in a second DL PDU associated with the MAC layer, for example (e.g., a DL MAC PDU), and transmits the second DL PDU to the UE 102 without first causing the UE 102 to transition from the RRC_INACTIVE or RRC_IDLE state to the RRC_CONNECTED state. In some implementations, the base station 104 includes the DL PDCP PDU in a DL RLC PDU, includes the DL RLC PDU in the DL MAC PDU, and transmits the DL MAC PDU to the UE 102 without first causing the UE 102 to transition from the RRC_INACTIVE or RRC_IDLE state to the RRC_CONNECTED state.

In another implementation, the base station 104 transmits the first DL PDU to the base station 106, which then generates a second PDU (e.g., a DL MAC PDU) including the first DL PDU and transmits the second DL PDU to the UE 102 without first causing the UE 102 to transition from the RRC_INACTIVE or RRC_IDLE state to the RRC_CONNECTED state. In some implementations, the base station 106 generates a DL RLC PDU including the first DL PDU and includes the DL RLC PDU in the second DL PDU. In yet another implementation, the base station 104 includes the first DL PDU in a DL RLC PDU and transmits the DL RLC PDU to the base station 106, which then generates a second DL PDU (e.g., a DL MAC PDU) including the DL RLC PDU and transmits the second DL PDU to the UE 102.

In some implementations, the base station (i.e., the base station 104 or 106) generates a downlink control information (DCI) and a cyclic redundancy check (CRC) scrambled with an ID of the UE 102 to transmit the second DL PDU generated by the base station. In some implementations, the ID of the UE 102 can be a Radio Network Temporary Identifier (RNTI). For example, the RNTI can be a cell RNTI (C-RNTI), a temporary C-RNTI, or an inactive C-RNTI. The base station transmits the DCI and scrambled CRC on a physical downlink control channel (PDCCH) to the UE 102 operating in the RRC_INACTIVE or RRC_IDLE state. The base station scrambles the CRC with the ID of the UE 102. In some implementations, the base station may assign the ID of the UE 102 to the UE 102 in a random access response that the base station transmits in a random access procedure with the UE 102 before transmitting the DCI and scrambled CRC. In other implementations, the base station may assign the ID of the UE 102 to the UE 102 in an RRC message (e.g., RRC release message or an RRC reconfiguration message) that the base station transmits to the UE 102 before transmitting the DCI and scrambled CRC, e.g., while the UE 102 was in the RRC_CONNECTED state.

The UE 102 operating in the RRC_INACTIVE or RRC_IDLE state can receive the DCI and scrambled CRC on the PDCCH. Then the UE 102 confirms that a physical downlink shared channel (PDSCH), including the second DL PDU, is addressed to the UE according to the ID of the UE 102, DCI, and scrambled CRC. The UE 102 then can retrieve the data from the security-protected packet. If the security-protected packet is an encrypted packet, the UE 102 can decrypt the encrypted packet using the appropriate decryption function and the security key to obtain the data. If the security-protected packet is the integrity-protected packet including the data and the MAC-I, the UE 102 can determine whether the MAC-I is valid. If the UE 102 confirms that the MAC-I is valid, the UE 102 retrieves the data. If, however, the UE 102 determines that the MAC-I is invalid, the UE 102 discards the packet. Finally, when the security-protected packet is both encrypted and integrity-protected, with encrypted data and an encrypted MAC-I, the UE 102 can decrypt the encrypted packet and encrypted MAC-I to obtain the data and the MAC-I. The UE 102 then can verify that the MAC-I is valid for the data. If the UE 102 confirms that the MAC-I is valid, the UE 102 retrieves and processes the data. Otherwise, when the UE 102 determines that the MAC-I is invalid, the UE 102 discards the data.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a Medium Access Control (MAC) controller 132 configured to perform a random access procedure with one or more user devices, receive uplink MAC protocol data units (PDUs) to one or more user devices, and transmit downlink MAC PDUs to one or more user devices. The processing hardware 130 can also include a Packet Data Convergence Protocol (PDCP) controller 134 configured to transmit DL PDCP PDUs in accordance with which the base station 104 can transmit data in the downlink direction, in some scenarios, and receive UL PDCP PDUs in accordance with which the base station 104 can receive data in the uplink direction, in other scenarios. The processing hardware further can include an RRC controller 136 to implement procedures and messaging at the RRC sublayer of the protocol communication stack. The processing hardware 130 in an example implementation includes an RRC inactive controller 138 configured to manage uplink and/or downlink communications with one or more UEs operating in the RRC_INACTIVE or RRC_IDLE state. The base station 106 can include generally similar components. In particular, components 140, 142, 144, 146, and 148 can be similar to the components 130, 132, 134, 136, and 138, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes an RRC inactive controller 158 configured to manage uplink and/or downlink communications when the UE 102 operates in the RRC_INACTIVE state. The processing hardware 150 in an example implementation includes a MAC controller 152 configured to perform a random access procedure with a base station, transmit uplink MAC PDUs to the base station, and receive downlink MAC PDUs from the base station. The processing hardware 150 can also include a PDCP controller 154 configured to transmit DL PDCP PDUs in accordance with which the base station 106 can transmit data in the downlink direction, in some scenarios, and receive UL PDCP PDUs in accordance with which the base station 106 can receive data in the uplink direction, in other scenarios. The processing hardware further can include an RRC controller 156 to implement procedures and messaging at the RRC sublayer of the protocol communication stack.

FIG. 1B depicts an example, distributed or disaggregated implementation of any one or more of the base stations 104, 106. In this implementation, the base station 104, 106 includes a central unit (CU) 172 and one or more DUs 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller, and/or an RRC inactive controller such as PDCP controller 134, 144, RRC controller 136, 146 and/or RRC inactive controller 138, 148. In some implementations, the CU 172 can include a radio link control (RLC) controller configured to manage or control one or more RLC operations or procedures. In other implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or a RLC controller configured to manage or control one or more RLC operations or procedures. The process hardware can also include a physical layer controller configured to manage or control one or more physical layer operations or procedures.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. The CU-CP 172A can be connected to one or more DU 174s through an F1-C interface. The CU-UP 172B can be connected to one or more DU 174 through the F1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions.

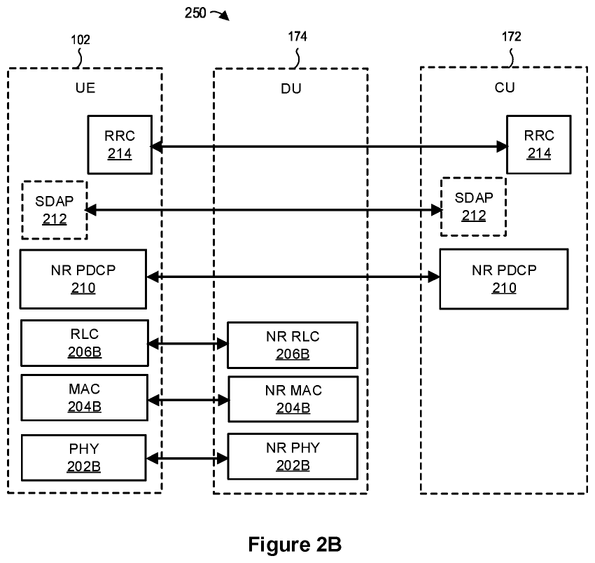

FIG. 2A illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to a NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2A) to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

FIG. 2B illustrates, in a simplified manner, an example protocol stack 250 which the UE 102 can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

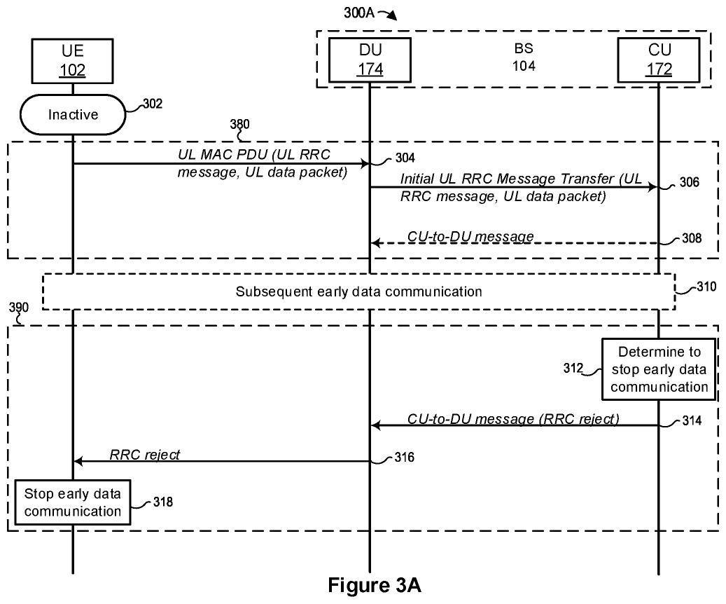

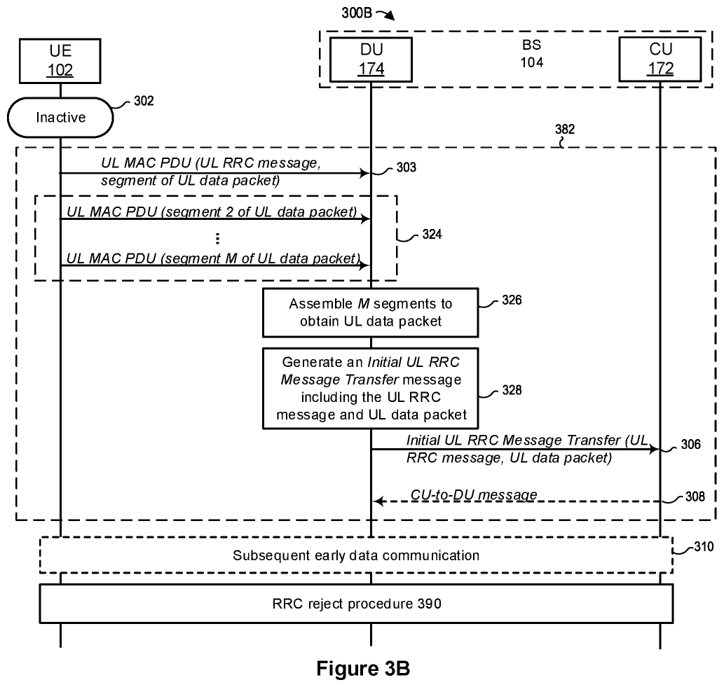

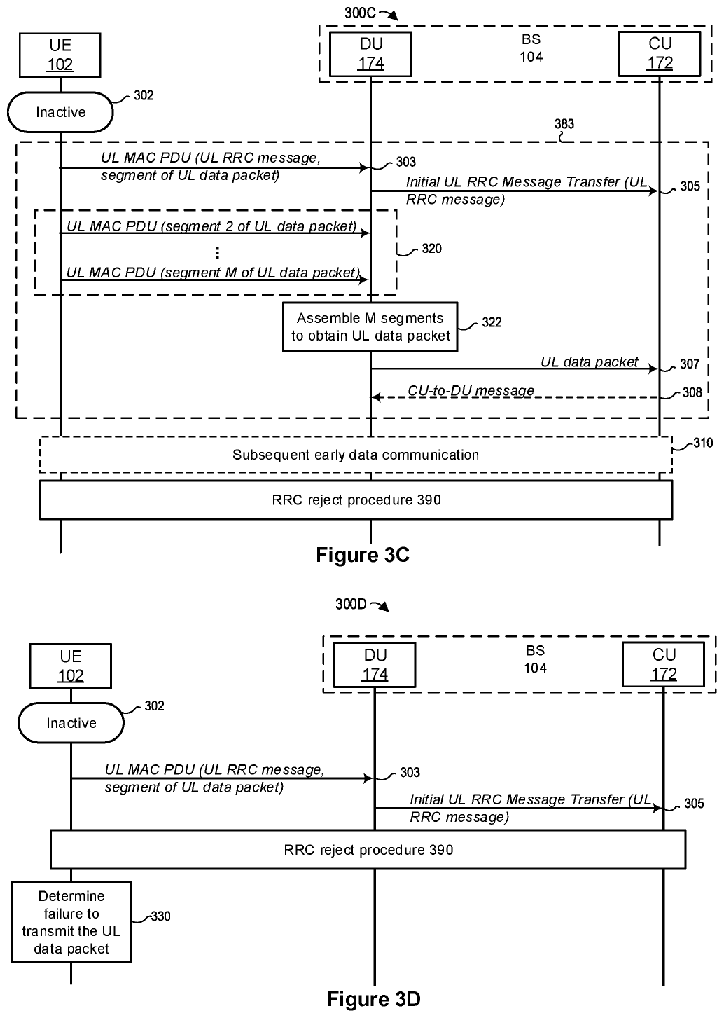

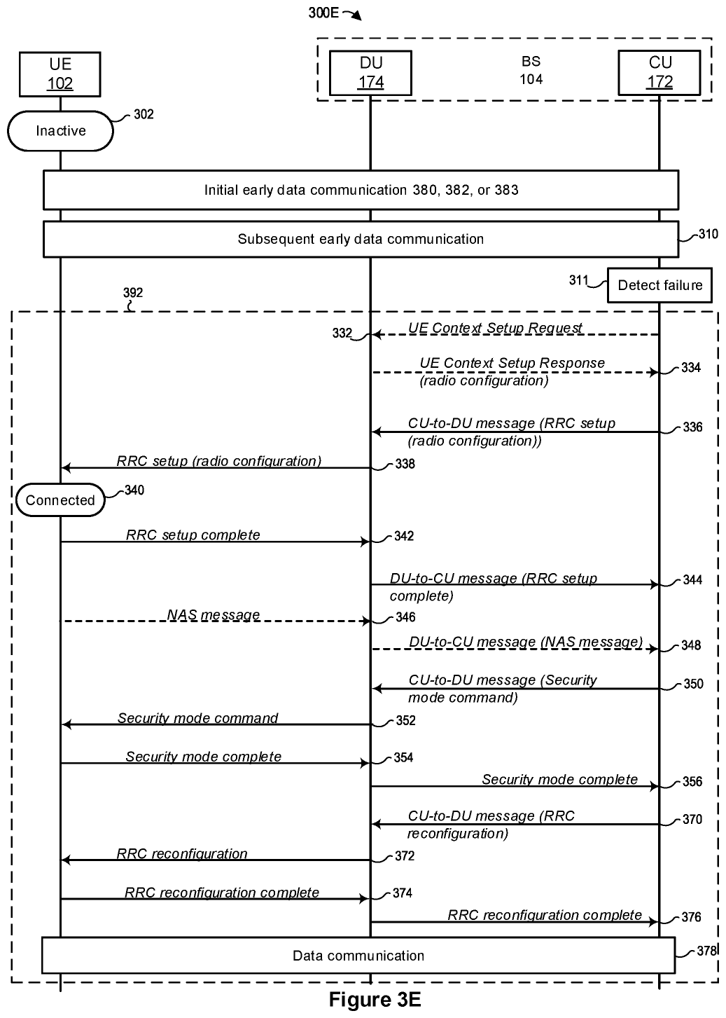

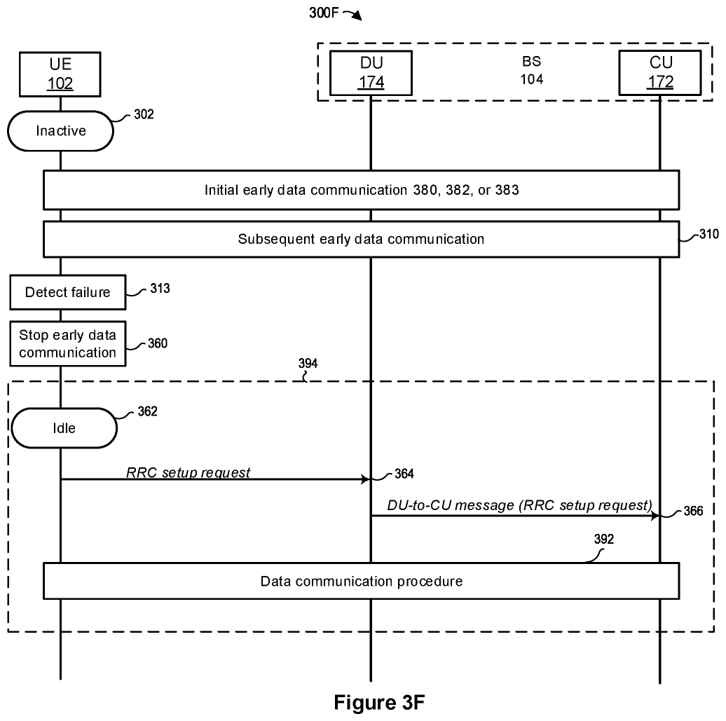

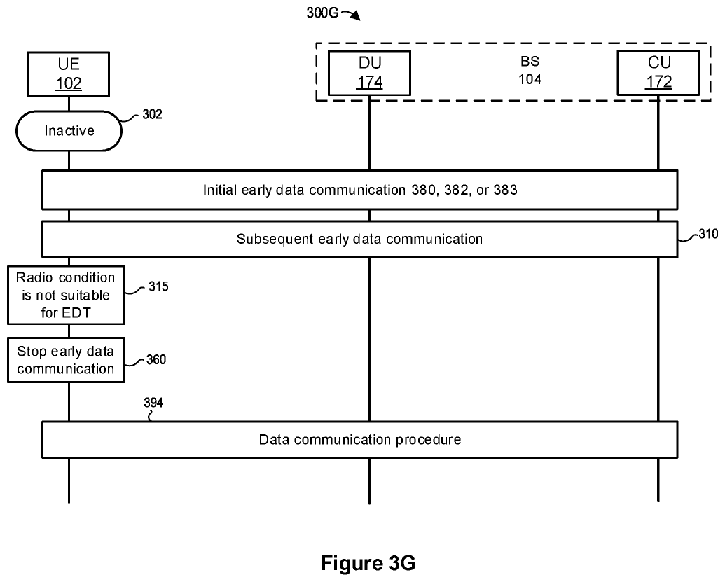

Next, several example scenarios that involve several components of FIG. 1A and relate to transmitting and/or receiving data in an inactive or idle state are discussed with reference to FIGS. 3A-3G. Generally speaking, events in FIGS. 3A-3G that are the same are labeled with the same reference numbers. To simplify the following description, the “inactive state” can represent the RRC_INACTIVE or RRC_IDLE state, and the connected state can represent the RRC_CONNECTED state.

Referring first to FIG. 3A, in a scenario 300A, the UE 102 initially operates 302 in an inactive state (e.g., RRC_INACTIVE or RRC_IDLE) with the base station 104 including a CU 172 and a DU 174. In some scenarios and implementations, the UE 102 previously operated in a connected state with the RAN 105 (e.g., the base station 104, base station 106, or another base station not shown in FIG. 1A), before transitioning to the inactive state. After a certain period of data inactivity for the UE 102, the RAN 105 can determine that neither the RAN 105 nor the UE 102 has transmitted any data in the downlink direction or the uplink direction, respectively, during the certain period. In response to the determination, the RAN 105 can transmit an RRC release message (e.g., RRCRelease message or RRCConnectionRelease message) to the UE 102 and instruct the UE 102 to transition to the inactive state. The UE 102 transitions to the inactive state upon receiving the first RRC release message and operates 302 in the inactive state. The RAN 105 can assign an I-RNTI or a resume identity/identifier (ID) to the UE 102 and include the assigned value in the RRC release message. After the UE 102 transitions to the inactive state, the UE 102 may perform one or more RAN notification area (RNA) updates with the CU 172 via the DU 174 without state transitions, in some cases. In other cases, after the UE 102 transitions to the inactive state, the UE 102 may perform early data communication with the CU 172 via the DU 174 without state transitions, similar to events 380, 303, 324, 320, and 310, where events 303, 324, and 320 are discussed below with reference to FIGS. 3B-3C.

At a later time, the UE 102 in the inactive state initiates early data communication to transmit uplink (UL) data or receive downlink (DL) data. The UE 102 can initiate early data communication in order to transmit at least one UL data packet or to receive at least one DL data packet. In cases where the UE 102 initiates EDT to transmit UL data while the UE 102 is in the inactive state, the initial early data communication can be mobile originating (MO) early data transmission (EDT). In cases where the UE 102 initiates EDT to receive DL data while the UE 102 is in the inactive state, the initial early data communication can be mobile terminating (MT) EDT (i.e., early data reception from the viewpoint of the UE 102). In such cases, the UE 102 at event 302 receives from the DU 174 a paging message, which includes a UE ID of the UE 102 and an EDT indication. For example, the UE ID can be an I-RNTI, resume ID, or a NAS ID (e.g., S-TMSI or 5G-S-TMSI, or a specific ID for MT EDT). In response to the paging message (i.e., the UE ID and the EDT indication), the UE 102 initiates early data communication to receive DL data from the DU 174 and CU 172.

In response to or after initiating early data communication, the UE 102 generates an initial UL MAC PDU including a UL RRC message and transmits 304 the initial UL MAC PDU to the DU 174 on cell 124. The DU 174 retrieves the UL RRC message from the initial UL MAC PDU and generates an Initial UL RRC Message Transfer message including the UL RRC message. Then, the DU 174 sends 306 the Initial UL RRC Message Transfer message to the CU 172.

In scenarios in which the UE 102 initiates early data communication to transmit UL data, such as the scenario 300A, the UE 102 includes at least one UL data packet in the initial UL MAC PDU that the UE 102 transmits 304. In scenarios in which the UE 102 initiates early data communication to receive DL data, the UE 102 does not include an UL data packet in the UL MAC PDU that the UE 102 transmits 304. In such scenarios, the UE 102 can include an EDT indication in the UL MAC PDU or the UL RRC message to indicate to the base station 104 that the UE 102 is initiating early data communication to receive DL data.

If the UE 102 includes UL data in the initial UL MAC PDU, the DU 174 retrieves the UL data from the initial UL MAC PDU. In such cases, the DU 174 can include the UL data in the Initial UL RRC Message Transfer message. Alternatively, the DU 174 can send the UL data to the CU 172 separately, e.g., via a user-plane (UP) connection as described below. After receiving the Initial UL RRC Message Transfer message, the CU 172 in some implementations sends 308 a first CU-to-DU message to the DU 174 to establish a UE Context of the UE 102 at the DU 174 and/or a UP connection between the CU 172 and DU 174 (e.g., F1-U tunnel or W1-U tunnel) for receiving the UL data and/or subsequent early data communication. In response, the DU 174 can send (not shown) a first DU-to-CU message to the CU 172. In some implementations, the first CU-to-DU message and the first DU-to-CU message can be a UE Context Setup Request message and a UE Context Setup Response message, respectively. The events 304, 306, and 308 are collectively referred to in FIG. 3A as an initial early data communication 380. While not shown in FIG. 3A, if the UE 102 initiates early data communication in order to receive DL data, then after receiving 306 the Initial UL RRC Message Transfer message, the CU 172 transmits, to the UE 102 via the DU 174, at least one DL data packet. Thus, initial early data communication 380 may include the CU 172 receiving 306 an UL data packet from the UE 102, as shown in FIG. 3A, or may include the CU 172 transmitting a DL data packet to the UE 102.

The CU 172 refrains from transitioning the UE 102 to a connected state during the initial early data communication 380. If the CU 172 determines that there is additional UL or DL data to communicate with the UE 102 consistent with early data communication constraints, the CU 172 performs 310 subsequent early data communication with the UE 102. During the subsequent early data communication 310, the CU 172, via the DU 174, can transmit one or more DL data packets to the UE 102 and receive one or more UL data packets from the UE 102. Further, the UE 102 refrains from transitioning to the connected state during the subsequent early data communication 310. More particularly, during the subsequent early data communication 310, the UE 102 operating in the inactive state can transmit to the DU 174 one or more UL MAC PDU(s), where each UL MAC PDU can include a particular data packet or a particular segment of a data packet, and/or the DU 174 can receive one or more data packets from the CU 172 and transmit, to the UE 102, one or more DL MAC PDU(s), where each DL MAC PDU can include a particular data packet or a particular segment of a data packet. When the DU 174 receives all segments of a data packet from the UE 102, the DU 174 assembles the segments to obtain the data packet, and send the data packet to the CU 172. When the UE 102 receives all segments of a data packet from the DU 174, the UE 102 assembles the segments to obtain the data packet. Alternatively, when the DU 174 receives one or more segments of a data packet from the UE 102 operating in the inactive state, the DU 174 forwards the one or more segments of the data packet to the CU 172. When the CU 172 receives all segments of a data packet from the UE 102 via the DU 174, the CU 172 assembles the segments to obtain the data packet. Data segmentation is discussed in further detail below with reference to FIGS. 3B-3C.

The (UL/DL) data that the UE 102 and base station 104 communicate while performing early data communication (i.e., the initial early data communication 380 and/or the subsequent early data communication 310) can include at least one data packet for an application or a protocol layer. In some example scenarios, the protocol layer can be a mobility management (MM) layer (e.g., 5G MM), a session management (SM) layer (e.g., 5G SM), an LTE positioning protocol (LPP) layer, or a secure user-plane location (SUPL) protocol layer. The data packet can be an Internet Protocol (IP) packet, an Ethernet packet, or an application packet. In other scenarios, the data packet is a PDCP PDU that includes an RRC PDU, a MM PDU, a SM PDU, LPP PDU, an IP packet, an Ethernet packet, or an application packet. Still further, the data packet in some scenarios can be an RRC PDU including a NAS PDU, such that the NAS PDU includes an IP packet, an Ethernet packet, or an application packet. In some implementations, the UE 102 can determine whether the UL data qualifies for transmission in the inactive state in view of one or more of such factors as whether the data is an IMS packet, whether the UL data is associated with a radio bearer (e.g., DRB or SRB) not suitable or configured for early data transmission, whether the UL data is an NAS message for initiating a particular NAS procedure, the size of the data, etc. When the UE 102 determines that the data does not qualify for transmission in the inactive state, the UE 102 can perform an RRC procedure (e.g., RRC connection establishment procedure or RRC resume procedure) to transition to the connected state.

After receiving 306 the UL data or performing 310 the subsequent early data communication with the UE 102 via the DU 174, the CU 172 determines 312 to stop the early data communication. In response to the determination, the CU 172 can send 314 a second CU-to-DU message including an RRC reject message to the DU 174. In turn, the DU 174 sends 314 the RRC reject message to the UE 102. In response to the RRC reject message, the UE 102 stops 318 the early data communication. In some implementations, the CU 172 determines 312 to stop early data communication in response to detecting a failure during the early data communication or receiving from the DU 174 an indication of a failure. For example, the failure can be a security error (e.g., integrity check error), a block error rate (BLER) above a threshold, failure to transmit a particular transmission (e.g., radio link control (RLC) protocol data unit (PDU)) in a maximum number of transmissions, or expiry of a timer run at the CU 172 or DU 174. The CU 172 can detect the security error on the UL data received at event 306 or 310. In other implementations, the CU 172 determines 312 to stop early data communication in response to other trigger events different from detecting an error or failure. For example, the CU 172 may determine to stop the early data communication due to congestion detected at the CU 172, or due to determining that there is no additional UL or DL data to communicate with the UE 102 using early data communication.

In some implementations, in response to the RRC reject message the UE 102 releases at least one RLC entity that the UE 102 used in the initial early data communication 380 and/or the subsequent early data communication 310. When the UE 102 has data to send or receives a paging message including an MT EDT indication from the RAN 105, the UE 102 can establish at least one RLC entity for a second initial early data communication and/or a second (subsequent) early data communication with the RAN 105 (e.g., DU 174 or another DU and CU 172 and/or another CU), similar to the initial early data communication 380 and/or the subsequent early data communication 310, respectively. In other implementations, the UE 102 reestablishes at least one RLC entity that the UE 102 used during the initial early data communication 380 or the subsequent early data communication 310 in response to receiving the RRC reject message or before performing the second initial early data communication and/or the second early data communication. In some implementations, the UE 102 releases a MAC entity that the UE 102 used in the initial early data communication 380 and/or the subsequent early data communication 310 in response to the RRC reject message. When the UE 102 has data to send or receives a paging message including an MT EDT indication from the RAN 105, the UE 102 can establish a MAC entity for the second initial early data communication and/or the second (subsequent) early data communication, similar to the initial early data communication 380 and/or the subsequent early data communication 310, respectively. In other implementations, the UE 102 resets a MAC entity that the UE 102 used in the initial early data communication 380 and/or the subsequent early data communication 310 in response to the RRC reject message.

In some implementations, in response to the RRC reject message the UE 102 releases at least one PDCP entity that the UE 102 used in the initial early data communication 380 and/or the subsequent early data communication 310. When the UE 102 has data to send or receives a paging message including an MT EDT indication from the RAN 105, the UE 102 can establish at least one PDCP entity for a second initial early data communication and/or a second (subsequent) early data communication with the RAN 105 (e.g., the DU 174 or another DU and the CU 172 and/or another CU), similar to the initial early data communication 380 and/or the subsequent early data communication 310, respectively. In other implementations, the UE 102 reestablishes at least one PDCP entity that the UE 102 used during the initial early data communication 380 or the subsequent early data communication 310 in response to receiving the RRC reject message or before performing the second initial early data communication and/or the second early data communication. In yet other implementations, the UE 102 suspends at least one PDCP entity that the UE 102 used during the initial early data communication 380 or the subsequent early data communication 310 in response to receiving the RRC reject message or before performing the second initial early data communication and/or the second early data communication. When the UE 102 has data to send or receives a paging message including an MT EDT indication from the RAN 105, the UE 102 can resume the at least one PDCP entity for a second initial early data communication and/or a second (subsequent) early data communication with the RAN 105 (e.g., the DU 174 or another DU and the CU 172 and/or another CU), similar to the initial early data communication 380 and/or the subsequent early data communication 310, respectively.

In some implementations, the DU 174 releases at least one RLC entity that the DU 174 used in the initial early data communication 380 and/or the subsequent early data communication 310 in response to the CU-to-DU message that the DU 174 receives 314. When the DU 174 receives a third CU-to-DU message for a second initial early data communication, similar to the first CU-to-DU message 308, the DU 174 establishes a RLC entity in response to the third CU-to-DU message.

In some implementations, the CU 172 releases at least one PDCP entity that the CU 172 used in the initial early data communication 380 and/or the subsequent early data communication 310 in response to the determination 312 or transmitting the RRC reject message. When the CU 172 receives a second Initial UL RRC Message Transfer message from the DU 174 for a second initial early data communication and/or a second (subsequent) early data communication with the UE 102, the CU 172 can establish at least one PDCP entity for the second initial early data communication and/or the second (subsequent) early data communication with the UE 102, similar to the initial early data communication 380 and/or the subsequent early data communication 310, respectively. In other implementations, the CU 172 reestablishes at least one PDCP entity that the CU 172 used during the initial early data communication 380 or the subsequent early data communication 310 in response to the determination 312, transmitting the RRC reject message or receiving the second initial UL RRC Message Transfer message. In yet other implementations, the CU 172 suspends at least one PDCP entity that the CU 172 used during the initial early data communication 380 or the subsequent early data communication 310 in response to the determination 312 or transmitting the RRC reject message. When the CU 172 receives a second initial UL RRC Message Transfer message from the DU 174 for a second initial early data communication and/or a second (subsequent) early data communication with the UE 102, the CU 172 can resume the at least one PDCP entity for the second initial early data communication and/or the second (subsequent) early data communication with the UE 102, similar to the initial early data communication 380 and/or the subsequent early data communication 310, respectively.

In some implementations, the UE 102 sends 304 the initial UL MAC PDU and/or performs 310 the subsequent early data communication using preconfigured uplink resources (PUR) without performing a random access procedure with the DU 174. In one implementation, the CU 172 can include configuration parameters in an RRC message (e.g., the first RRC release message, another RRC release message, an RRC reconfiguration message, or a PUR configuration response message) to configure the PUR and send the RRC message to the UE 102 via the DU 174. In some implementations, the CU 172 can include a PUR configuration (e.g., PUR-Config), a configured grant (CG) configuration, a list of PUR configurations, or a list of CG configurations, which includes the configuration parameters, in the RRC message. In some implementations, the UE 102 retains the configuration parameters (e.g., a PUR configuration (e.g., PUR-Config), a configured grant (CG) configuration, a list of PUR configurations, or a list of CG configurations) in response to the RRC reject message. In other implementations, the UE 102 releases the configuration parameters in response to the RRC reject message. In such cases, the UE 102 performs a random access procedure to perform the second initial early data communication with the RAN 105.

In some implementations, the second CU-to-DU message that the CU 172 transmits 314 can be a UE Context Release Command message. In such cases, the DU 174 can send a UE Context Release Complete message to the CU 172 in response to the UE Context Release Command message. In other implementations, the second CU-to-DU message can be a DL RRC Message Transfer message. In this case, the CU 172 can send a UE Context Release Command message to the DU 174 in response to determining 312 to stop early data communication. In response, the DU 174 can send a UE Context Release Complete message to the CU 172.

The UE 102 can process available UL data in view of the RRC reject message. More particularly, in response to receiving 316 the RRC reject message, the UE 102 stops 318 early data communication and processes any available UL data. In some implementations, the UE 102 initiates second initial early data communication (e.g., MO EDT) to send UL data to the CU 172 via the DU 174 after stopping 318 the early data communication. To initiate the second initial early data communication, the UE 102 can send an UL MAC PDU including an UL RRC message to the base station 104 (similar to the event 304). Thus, receiving 316 the RRC reject message triggers the UE 102 to re-initiate early data communication. In some implementations, the UL data is fresh data that the UE 102 generates after stopping the early data communication. In other implementations, the UL data can be data the UE 102 generated and did not transmit before receiving the RRC reject message. In yet other implementations, the UL data can be data that the UE 102 attempted to transmit during the initial early data communication 380 or the subsequent early data communication 310. For example, the UL data can be data that the UE 102 generated and transmitted at least a portion of before receiving the RRC reject message, discussed with reference to FIG. 3D. As another example, the UL data can be data the UE 102 transmitted to the base station 104 but was not acknowledged by the base station 104.

In some implementations, the CU 172 includes a barring timer value in the RRC reject message. In response to receiving 316 the RRC reject message, the UE 102 can start a barring timer with the barring timer value. In such cases, the UE 102 refrains from performing an initial early data communication until the barring timer expires. After the barring timer expires, the UE 102 can perform another initial early data communication (e.g., the second initial early data communication which can be an MO EDT or MT EDT) with the RAN 105 similar to the initial early data communication 380. If the UE 102 receives from the RAN 105 (e.g., DU 174 or another DU) a paging message including an EDT indication while the barring timer is running, the UE 102 can perform an MT EDT with the RAN 105 (e.g., with the CU 172 or another CU via DU 174 or another DU), similar to the initial early data communication 380.

The events 312, 314, 316, and 318 are collectively referred to in FIG. 3A as an RRC reject procedure 390.

Turning to FIG. 3B, a scenario 300B is generally similar to the scenario 300A. However, during initial early data communication, the UE 102 segments an UL data packet before transmitting the UL data packet to the DU 174. The UE 102 may determine to segment an UL data packet if a single UL MAC PDU cannot accommodate the whole UL data packet. Initially, the UE 102 operating 302 in the inactive state transmits 303 an UL MAC PDU including an UL RRC message and a first segment of an UL data packet. After transmitting 303 the first data segment, the UE 102 transmits 324 to the DU 174 subsequent UL MAC PDU(s) (e.g., M−1 UL MAC PDU(s), where M is a natural number and larger than 1), where each subsequent UL MAC PDU includes a segment of the UL data packet. After receiving 324 the M segments of the UL data packet, the DU 174 assembles 326 the M segments to obtain the UL data packet. The DU 174 can then generate 328 an Initial UL RRC Message Transfer message including the UL RRC message and the assembled UL data packet. The DU 174 transmits 306 the Initial UL RRC Message Transfer message to the CU 172. After receiving the Initial UL RRC Message Transfer message, the CU 172 may send 308 a first CU-to-DU message to the DU 174 to establish a UE Context of the UE 102 at the DU 174 for subsequent early data communication. The events 303, 324, 326, 328, 306, and 308 are collectively referred to in this disclosure as an initial early data communication 382. While not illustrated in FIG. 3B, in the case of initial early data communication including MT EDT, the DU 174 can receive a DL data packet from the CU 172, divide the DL data packet into segments, and transmit segments of the DL data packet in respective, separate DL MAC PDUs to the UE 102.

Turning to FIG. 3C, a scenario 300C is generally similar to the scenario 300B. However, the DU 174 transmits 305 an Initial UL RRC Message Transfer message including the UL RRC message that the DU 174 receives 303 before receiving all M segments of the UL data packet. After transmitting the Initial UL RRC Message Transfer message, the DU 174 continues to receive 320 segments 2 through M of the UL data packet. After receiving the M segments of the UL data packet, the DU 174 assembles 322 the M segments to obtain the UL data packet. The DU 174 can then send 307 the UL data packet to the CU 172, separately from the Initial UL RRC Message Transfer message that the DU 174 transmits 305. The events 303, 305, 320, 322, 307, and 308 are collectively referred to in this disclosure as an initial early data communication 383.

Turning to FIG. 3D, a scenario 300D is similar to the scenarios 300A-300C, but where the UE determines that the base station failed to receive the UL data packet in response to receiving the RRC reject message. After transmitting 303 a UL MAC PDU including a UL RRC message and a segment of an UL data packet, the UE 102 receives an RRC reject message from the DU 174 during the RRC reject procedure 390. In response to receiving the RRC reject message, the UE 102 determines 330 that the UE 102 failed to transmit the UL data packet successfully (or, said another way, that the base station 104 failed to receive the UL data packet from the UE 102). In some implementations, such as described with reference to FIGS. 3B and 3C, the UE 102 may transmit one or more segments in addition to the first segment before receiving the RRC reject message. If the UE 102 does not transmit all M segments of the UL data packet before receiving the RRC reject message, then the UE 102 determines 330 that the UE 102 failed to transmit the UL data packet.

Referring next to FIG. 3E, in contrast to the scenario 300A where the UE remains in an inactive state in response to detecting a failure during early data communication, the CU 172 causes the UE 102 to transition to the connected state. Initially, the UE 102 operating 302 in the inactive state performs initial early data communication 380, 382, or 383 with the CU 172 and the DU 174 of the base station 104. During the initial early data communication, the UE 102 and the base station 104 exchange at least one UL or DL data packet. The UE 102 also performs subsequent early data communication 310 to exchange one or more additional data packets with the base station 104.

While performing the early data communication (i.e., the initial or subsequent early data communication), the CU 172 detects 311 a failure. Detecting the failure may include detecting a security error, determining that a number of attempted transmissions of uplink data exceeds a threshold, determining that a timer associated with the early data communication exceeds a threshold, or determining that a condition of a radio link is not suitable for early data communication (e.g., based on a BLER measurement or a signal measurement).

In response to detecting 311 the failure, the CU 172 stops performing the early data communication. However, instead of transmitting an RRC reject message (e.g., event 314), the CU 172 prepares an RRC setup message for the UE 102. To prepare the RRC setup message, the CU 172 may send 332 a UE Context Setup Request message to the DU 174. In response, the DU 174 sends 334 a UE Context Setup Response message including a radio configuration, where the radio configuration may include configuration parameters that the UE 102 can use to communicate with the DU 174 while operating in the connected state. The CU 172 then generates an RRC setup message, which may include the radio configuration, if retrieved from the DU 174. The CU 172 sends 336 the RRC setup message to the DU 174 in a CU-to-DU message. The DU 174 extracts the RRC setup message from the CU-to-DU message and transmits 338 the RRC setup message to the UE 102. In response to the RRC setup message, the UE 102 transitions 340 to the connected state.

After transitioning 340 to the connected state, the UE 102 transmits 342 an RRC setup complete message to the DU 174, which in turn sends 344 to the CU 172 in a CU-to-DU message. In some implementations, the UE 102 also transmits 346 a NAS message (e.g., a Service Request message) to the DU 174, which the DU 174 sends 348 to the CU 172 in a CU-to-DU message. The CU 172 can provide the NAS message to the CN 110, which may trigger the CN 110 to initiate a security procedure with the UE 102 via the CU 172. The CU 172 sends 350 a CU-to-DU message including a Security mode command message to the DU 174, and the DU 174 transmits 352 the Security mode command to the UE 102. In response, the UE 102 transmits 354 a Security mode complete message to the DU 174, which the DU 174 transmits 356 to the CU 172.

Further, the CU 172 transmits 370 a CU-to-DU message including an RRC reconfiguration message to the DU 174. The DU 174 extracts the RRC reconfiguration message and transmits 372 the RRC reconfiguration message to the UE 102. In response, the UE 102 transmits 374 an RRC reconfiguration complete message to the DU 174, which the DU 174 sends 376 to the CU 172. The UE 102 can then communicate 378 with the CU 172 via the DU 174 while operating in the connected state. The events 332, 334, 336, 338, 340, 342, 344, 346, 348, 350, 352, 354, 356, 370, 372, 374, 376, and 378 are collectively referred to in this disclosure as a data communication procedure 392.

Turning to FIG. 3F, in a scenario 300F, the UE 102 detects a failure during early data communication with the base station 104. More particularly, while performing early data communication (i.e., initial early data communication 380, 382, or 383, or subsequent early data communication 310), the UE 102 detects 313 a failure. For example, the failure can be a security error (e.g., integrity check error), a block error rate (BLER) above a threshold, failure to transmit a particular transmission (e.g., a protocol data unit (PDU)) in a maximum number of transmissions, or expiry of a timer (e.g., a time alignment timer (TAT)) at the UE 102.

In response to detecting 313 the failure, the UE 102 stops 360 the early data communication. Further, the UE 102 transitions 362 to the idle state (e.g., RRC_IDLE) and transmits 364 an RRC setup request message to the DU 174 in order to request transitioning to the connected state. The DU 174 sends to RRC setup request message to the CU 172 in a DU-to-CU message. In response, the CU 172 can perform the data communication procedure 392 to transition the UE 102 to the connected state. While operating in the connected state, the UE 102 can transmit any available UL data at the UE 102 to the base station 104 (e.g., fresh data that the UE 102 generates after stopping 360 the early data communication, data that the UE 102 generated and did not transmit before 360 stopping early data communication, or data that the UE 102 attempted to transmit during the initial early data communication or the subsequent early data communication 310). The events 362, 364, 366, and 392 are collectively referred to in this disclosure as a data communication procedure 394.

Turning to FIG. 3G, a scenario 300G is similar to the scenario 300G. However, the UE 102 stops 360 early data communication in response to determining 315 that a radio condition is not suitable for early data communication. For example, the UE 102 may detect that a BLER is above a threshold for early data communication, or that a signal measurement (e.g., a power or quality measurement, such as Reference Signal Received Power (RSRP) or Reference Signal Received Quality (RSRQ)) for the radio signal is below a threshold for early data communication.

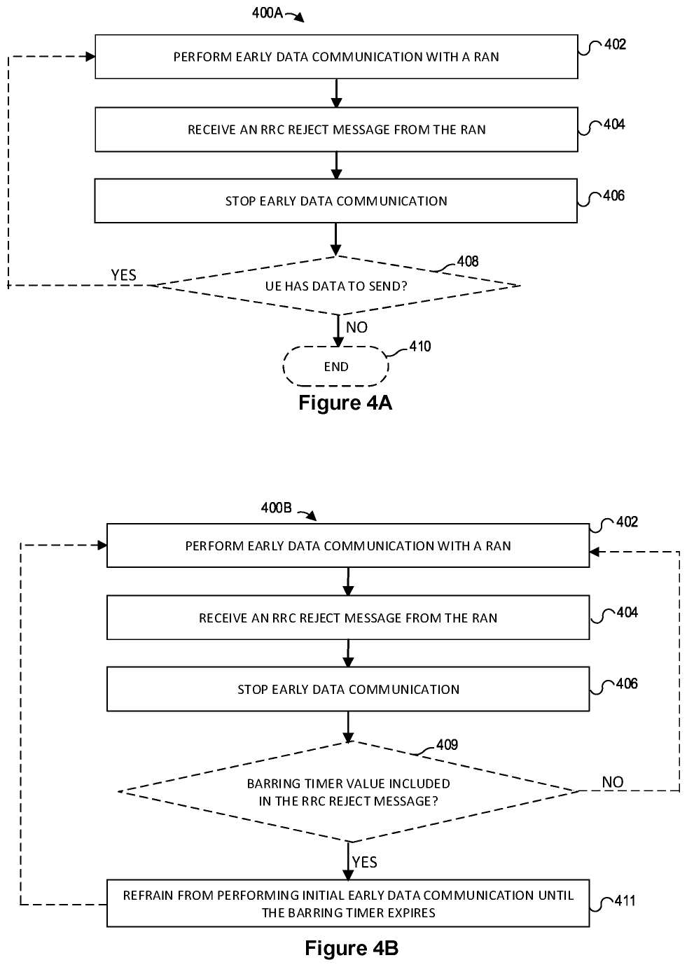

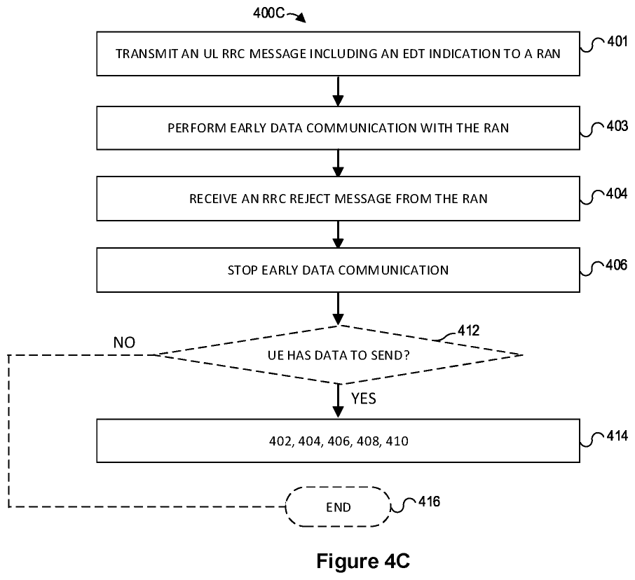

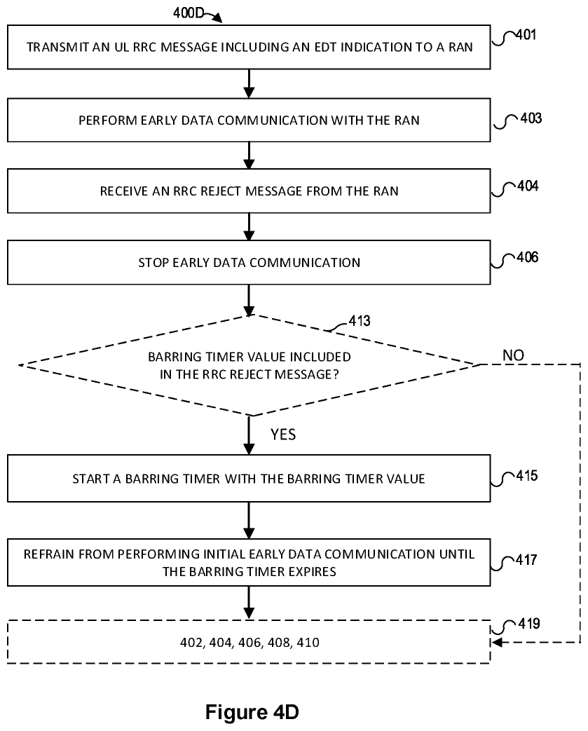

FIGS. 4A-11 are flow diagrams depicting example methods that nodes of a RAN (e.g., the RAN 105) or a UE (e.g., the UE 102) can implement for handling communication errors during early data communication while a radio resource control connection between the RAN and the UE is not active (e.g., while the UE 102 operates in an inactive or idle state, such as RRC_INACTIVE or RRC_IDLE).

In particular, FIGS. 4A-4D can be implemented by a UE. In FIGS. 4A-4D, blocks that are the same are labeled with the same reference number (e.g., block 406 in FIGS. 4A-4D).

FIG. 4A is a flow diagram of an example method 400A for stopping early data communication after receiving an RRC reject message. At block 402, the UE, operating in an inactive state, performs early data communication with a RAN (e.g., the RAN 105). Performing early data communication includes initiating early data communication to transmit a UL data packet or receive a DL data packet (e.g., events 380, 382, 383, 303) and may include performing subsequent early data communication to communicate additional UL and/or DL packets with the RAN (e.g., event 310). At block 404, the UE receives an RRC reject message from the RAN (e.g., events 316, 390). In response to the RRC reject message, the UE at block 406 stops early data communication (e.g., events 318, 390). In some implementations, the method 400A concludes after the UE stops the early data communication. In other implementations, the method 400A includes determining, at block 408, whether the UE has UL data to send to the RAN.

As discussed above with reference to FIG. 3A, in some implementations, the UL data is fresh data that the UE generates after stopping the early data communication. In other implementations, the UL data is data that the UE generated and did not transmit before receiving the RRC reject message. In yet other implementations, the UL data can be data that the UE attempted to transmit during the early data communication. For example, the UL data can be data that the UE generated and transmitted at least a portion of before receiving the RRC reject message, discussed above with reference to FIG. 3D. As another example, the data can be data the UE transmitted to the RAN but was not acknowledged by the RAN.

If the UE does have available UL data to send to the RAN, the flow proceeds from block 408 to block 402. At block 402, the UE reinitiates early data communication in order to transmit the UL data to the RAN using early data communication. If the UE does not have available UL data, then the flow ends at block 410.

In some implementations, in response to performing early data communication at block 402 (i.e., in response to initiating early data communication), the UE starts a timer. In response to stopping the early data communication, the UE stops the timer. If the timer expires before the UE receives the RRC reject message, then the UE stops the early data communication. In some implementations, in response to expiry of the timer, the UE transitions to an idle state and releases the inactive UE Context. In other implementations, in response to expiry of the timer, the UE remains in the inactive state and retains the inactive UE context.

FIG. 4B is a flow diagram of an example method 400B similar to the method of FIG. 4A, but where the UE reinitiates early data communication after a barring timer indicated the RRC reject message expires. After stopping the early data communication at block 406, the UE determines at block 409 whether a barring timer value is included in the RRC reject message. If so, then at block 411, then the UE starts a barring time with the barring timer value and refrains from reinitiating and performing early data communication until the barring timer expires. Otherwise, the UE can proceed from block 409 to block 402, where the UE reinitiates early data communication to transmit any available UL data to the RAN.

FIG. 4C is a flow diagram of an example method 400C similar to the method of FIG. 4A, but where the UE initiates the early data communication to receive downlink (DL) data. Accordingly, at block 401, the UE initiates early data communication by transmitting an UL RRC message including an EDT indication to the RAN. For example, the UE may transmit the UL RRC message including the EDT indication in response to receiving a paging message from the RAN including an EDT indication. At block 403, the UE performs early data communication with the RAN, which includes receiving a DL data packet from the RAN and may include communicating subsequent UL/DL packets with the RAN. After receiving an RRC reject message at block 404 and stopping early data communication at block 406, the UE determines at block 412 whether the UE has available data to send (similar to event 408). If so, then, at block 414, the flow proceeds to blocks 402, 404, 406, 408, and 410 (i.e., the method 400A). If not, then the flow ends at block 416.

FIG. 4D is a flow diagram of an example method 400D similar to the method of FIG. 4B, but where the UE initiates the early data communication to receive DL data. Thus, the method 400D begins similarly to the method 400C. After stopping the early data communication at block 406, at block 413, the UE determines whether a barring time value is included in the RRC reject message. If so, then at block 415 the UE starts a barring timer with the barring timer value. Then, at block 417, the UE refrains from performing initial early data communication until the barring timer expires. After the barring timer expires, at block 419, the flow proceeds to blocks 402, 404, 406, 408, and 410 (i.e., the method 400A). If the RRC reject message does not include a barring timer value, then the flow proceeds from block 413 to block 419.

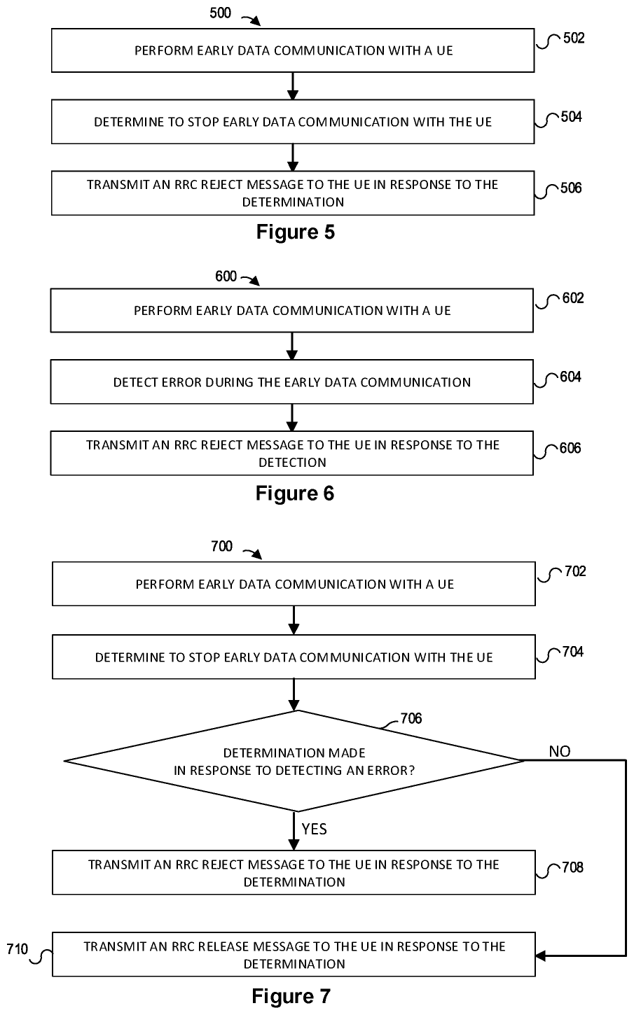

FIGS. 5-7 are flow diagrams of example methods that can be implemented by a base station (e.g., the base station 104), or a CU (e.g., the CU 172) of the base station, in communication with a UE (e.g., the UE 102). While the methods depicted in FIGS. 5-7 can be implemented by a base station or by a CU, for brevity, the description of FIGS. 5-7 refers to the base station.

FIG. 5 is a flow diagram of an example method 500 for transmitting an RRC reject message in response to stopping early data communication. At block 502, the base station performs early data communication with a UE. Performing early data communication includes performing initial early data communication to receive a UL data packet or transmit a DL data packet (e.g., events 380, 382, 383, 303) and may include performing subsequent early data communication to communicate additional UL and/or DL packets with the UE (e.g., event 310). At block 504, the base station determines to stop early data communication with the UE (e.g., event 312). In response to the determination at block 504, at block 506, the base station transmits an RRC reject message to the UE to instruct the UE to stop early data communication (e.g., events 314, 316).

FIG. 6 is a flow diagram of an example method 600 for transmitting an RRC reject message in response to detecting an error during early data communication with the UE. Similar to block 502, the base station at block 602 performs early data communication with the UE. At block 604, the base station detects an error during the early data communication (e.g., by detecting a failure discussed above with reference to event 312). At block 606, in response to detecting the error, the base station stops the early data communication and transmits an RRC reject message to the UE (e.g., events 314, 316).

FIG. 7 is a flow diagram of an example method 700 for determining whether to transmit an RRC reject message or an RRC release message after determining to stop early data communication. Initially, the base station performs early data communication with a UE at block 702 and determines to stop the early data communication at block 704. At block 706, the base station determines whether the determination at block 704 to stop the early data communication was made in response to detecting an error (e.g., in response to detecting a failure as discussed above with reference to event 312). If so, then the base station transmits an RRC reject message to the UE at block 708. Otherwise, then the base station transmits an RRC release message to the UE at block 710. For example, the base station may determine to stop early data communication in response to determining that there is no additional UL or DL data to communicate with the UE via early data communication. In such cases, the base station may transmit an RRC release message rather than an RRC reject message.

In some implementations, the base station can (determine to) transmit a RRC setup message to the UE instead of the RRC reject message if the base station determines, at block 706, that the determination at block 704 to stop the early data communication was made in response to detecting an error. In yet other implementations, the base station can (determine to) transmit the RRC reject message if the base station determines, at block 706, that the determination at block 704 to stop the early data communication was made in response to detecting a first-type error, and the base station can (determine to) transmit the RRC setup message if the base station determines, at block 706, that the determination at block 704 to stop the early data communication was made in response to detecting a second-type error. The first-type error and the second-type error may each be a different one of: a security error (e.g., an integrity check error) associated with UL data received from the UE during early data communication, a number of attempted transmissions of data to the UE exceeding a threshold, a BLER exceeding a threshold, or a timer associated with early data communication expiring. For example, the first-type error can be a timer associated with the early data communication expiring, and the second-type error can be security error, a number of attempted transmissions of data to the UE exceeding a threshold, or a BLER exceeding a threshold.

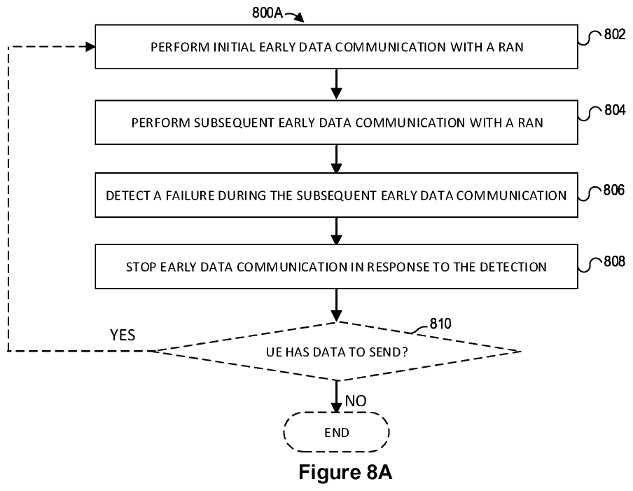

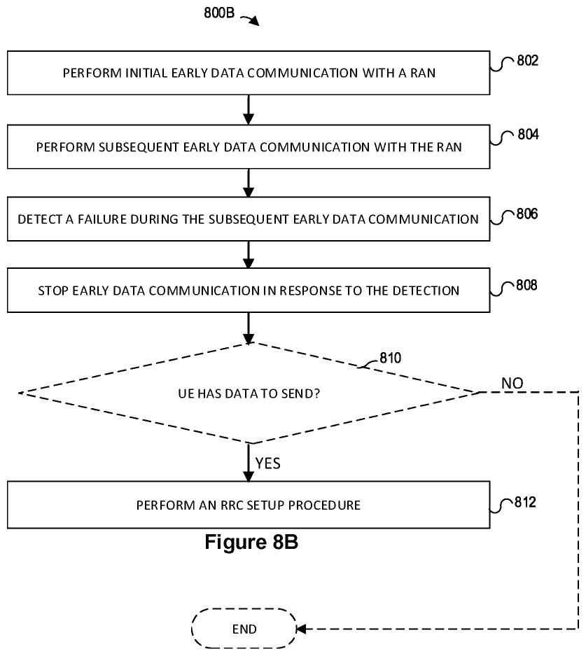

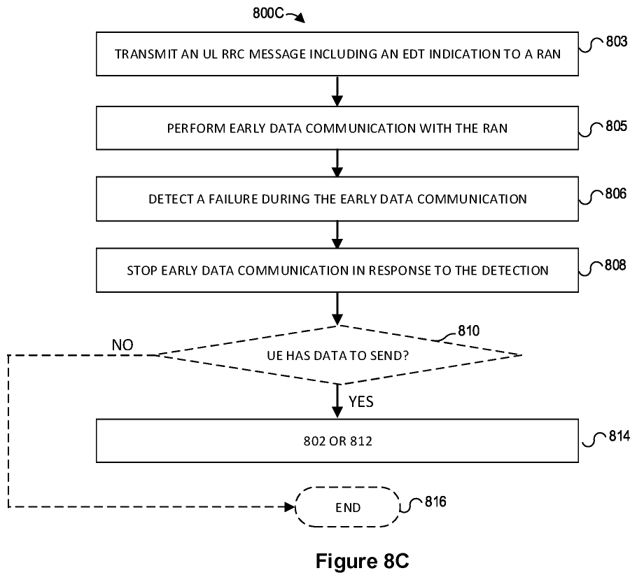

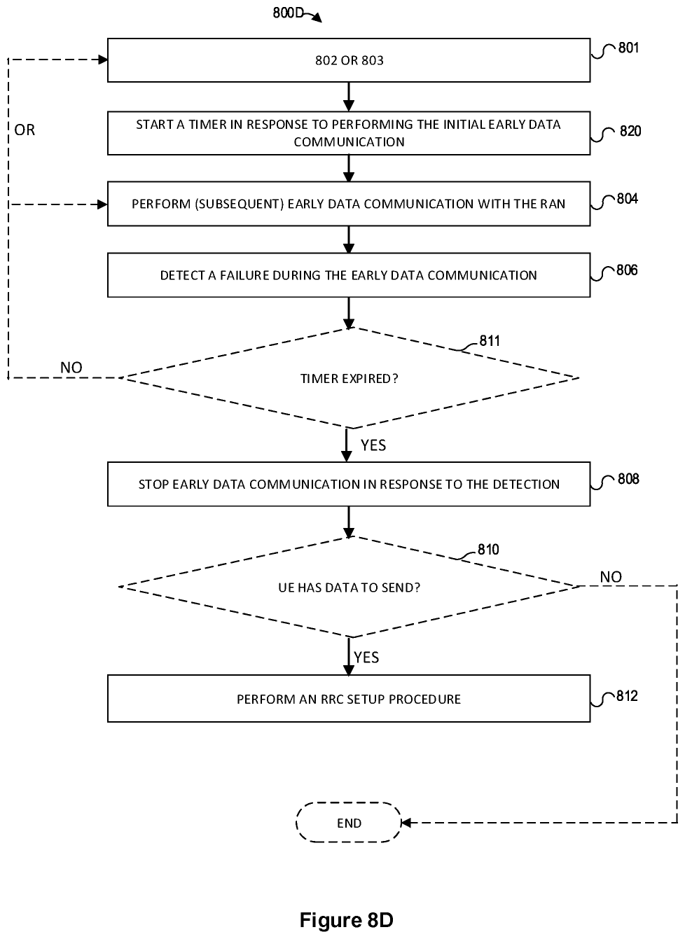

FIGS. 8A-8D are flow diagrams of example methods that a UE (e.g., the UE 102) can use while a radio resource control connection with a RAN (e.g., the RAN 105) is not active. In FIGS. 8A-8D, blocks that are the same are labeled with the same reference number (e.g., block 806 in FIGS. 8A-8D). FIGS. 8A-8D are generally similar to FIGS. 4A-4D, except that the UE detects a failure during early data communication with the RAN rather than receiving an RRC reject message from the RAN.

FIG. 8A is a flow diagram of an example method 800A for stopping early data communication in response to detecting a failure during the early data communication. At block 802, the UE performs initial early data communication with a RAN (e.g., events 380, 382, 383, 303). At block 804, the UE performs subsequent early data communication to communicate additional UL and/or DL packets with the RAN (e.g., event 310). At block 806, the UE detects a failure during the subsequent early data communication. Detecting the failure can include detecting a failure as discussed with reference to event 313, or detecting that the radio condition is not suitable for early data communication, as discussed with reference to event 315. In response to detecting the failure, the UE stops early data communication at block 808 (e.g., event 360). In some implementations, the method 800A concludes after the UE stops the early data communication. In other implementations, the method 800A includes determining, at block 810, whether the UE has UL data to send to the RAN (similar to block 408). If so, then the flow proceeds from block 810 to block 802, where the UE reinitiates early data communication in order to transmit the UL data to the RAN using early data communication. If the UE does not have available UL data, then the flow ends.

Similar to the FIG. 4A, in some implementations, in response to performing early data communication at block 802 (i.e., in response to initiating early data communication), the UE starts a timer. In response to stopping the early data communication, the UE stops the timer. If the timer expires before the UE detects the failure, then the UE stops the early data communication. In some implementations, in response to expiry of the timer, the UE transitions to an idle state and releases the inactive UE Context. In other implementations, in response to expiry of the timer, the UE remains in the inactive state and retains the inactive UE context.

FIG. 8B is a flow diagram of an example method 800B similar to the method of FIG. 8A, but where the UE performs an RRC setup procedure after stopping the early data communication. In particular, if the UE has data to send at block 810, instead of reinitiating early data communication, the UE performs an RRC setup procedure at block 812 (e.g., event 364, 394).

FIG. 8C is a flow diagram of an example method 800C similar to the methods of FIGS. 8A-8B, but where the UE initiates the early data communication to receive DL data. At block 803, the UE initiates early data communication by transmitting an UL RRC message including an EDT indication, similar to block 401. At block 805, the UE performs early data communication with the RAN, which includes receiving a DL data packet from the RAN and may include communicating subsequent UL/DL packets with the RAN. After detecting a failure during the early data communication at block 806 and stopping early data communication at block 808, the UE determines at block 810 whether the UE has available data to send. If so, then the flow can proceed either to block 802, where the UE reinitiates early data communication, or to block 812, where the UE performs an RRC setup procedure. Otherwise, the flow ends at block 816.

FIG. 8D is a flow diagram of an example method 800D similar to the method of FIG. 8B, but where the UE refrains from stopping the early data communication until a timer at the UE expires. At block 801, the UE performs initial early data communication as at either block 802 or block 803. To perform the initial early data communication, the UE can transmit an UL MAC PDU to the RAN. In some implementations, the UL MAC PDU includes an UL RRC message and at least a segment of an UL data packet (e.g., event 304). In other implementations, the UL MAC PDU includes an UL RRC message and an EDT indication, which indicates that the UE is initiating early data communication to receive a DL data packet.

At block 820, the UE starts a timer in response to performing the initial early data communication. The UE then performs subsequent early data communication with the RAN at block 804. During the early data communication, the UE detects a failure at block 806. At block 811, the UE determines whether the timer has expired. If not, then the flow can either return to block 801 or block 804. In some implementations, the UE recovers from the failure after detecting the failure and before the timer expires. For example, to detect the failure, the UE may determine that a radio condition is not suitable for early data communication. If the radio condition becomes suitable for early data communication before the timer expires, then the UE may perform early data communication at block 804 after detecting the failure at block 806. As another example, to detect the failure, the UE may determine that a TAT expires at the UE. In response, the UE may perform a random access procedure after detecting the failure in order to obtain a new timing advance command from the RAN. The UE can then restart the TAT timer in response to receiving the new timing advance command in a random access response, and perform early data communication. In other implementations, detecting the failure can correspond to detecting that the timer has expired.

If the timer has expired (and the UE has not successfully recovered from the failure), then the UE at block 808 stops early data communication in response to detecting the failure. If the UE has data to send at block 810, the UE can perform an RRC setup procedure at block 812. Otherwise, the flow ends.

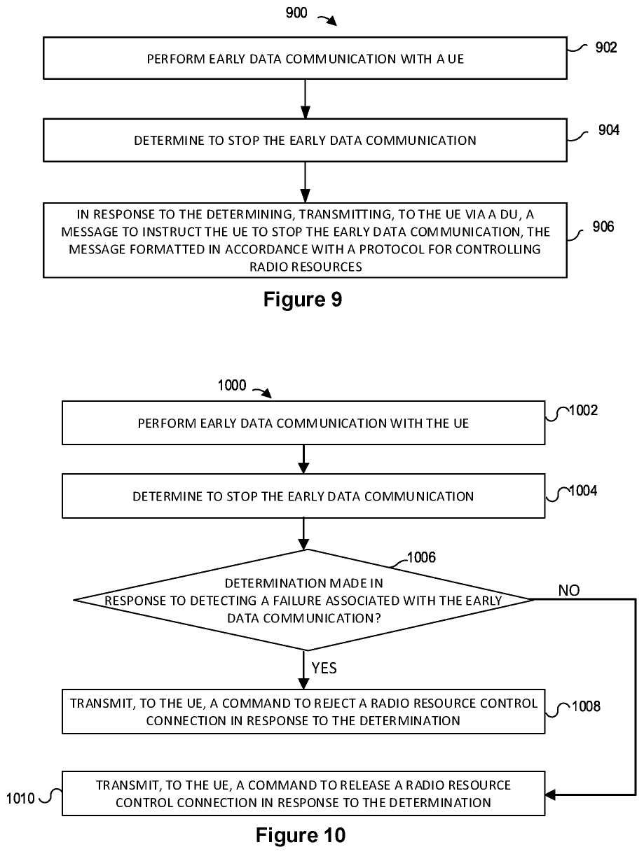

FIG. 9 is a flow diagram of an example method 900 that can be implemented by a CU (e.g., the CU 172) of a distributed base station (e.g., the base station 104) for handling communication errors when communicating with a UE (e.g., the UE 102) while a radio resource control connection between the UE and the distributed base station is not active. At block 902, the CU performs early data communication with a UE. Performing early data communication may include performing initial early data communication, including receiving an UL RRC message from the UE, via a DU of the distributed base station (e.g., events 306, 380, 382, 383, 305, 307). If the initial early data communication is for MO EDT, the UL RRC message indicates to the CU that the UE is initiating EDT, and the UL RRC message is accompanied with a UL data packet or a segment of an UL data packet. If the initial early data communication is for MT EDT, the UL RRC message may include an explicit EDT indication indicating that the UE is initiating EDT in order to receive a DL data packet. The UE may send the UL RRC message to the CU in response to receiving a paging message from the CU and/or a DU of the distributed base station including an EDT indication. In response to the UL RRC message and EDT indication, the CU transmits the DL data packet to the UE.

Further, performing early data communication may also include performing subsequent early data communication (e.g., event 310). After performing initial early data communication, the CU may exchange a plurality of additional DL or UL data packets with the UE during the subsequent early data communication.

At block 904, the CU determines to stop the early data communication (e.g., events 312, 390, 311). In some implementations, the CU detects a failure associated with the early data communication and determines to stop the early data communication in response to detecting the failure. Detecting the failure may include: receiving a failure indication from the DU, detecting a security error, detecting that a BLER is above a threshold, determining that a number of attempted transmissions of a PDU to the UE during the early data communication exceeds a threshold, or determining that a timer associated with the early data communication has expired.

At block 906, in response to determining to stop the early data communication at block 904, the CU transmits, to the UE via the DU, a message to instruct the UE to stop the early data communication, the message formatted in accordance with a protocol for controlling radio resources (e.g., events 314, 390, 336, 392). For example, the message can be a command to reject the radio resource control connection (e.g., RRC reject message, such as an RRCReject message), or a command to set up a new radio resource control connection (e.g., an RRC setup message, such as an RRCSetup message).

FIG. 10 is a flow diagram of another example method 1000 that can be implemented by a base station (e.g., the base station 104, or the CU 172 of the base station 104) for handling communication errors when communicating with a UE (e.g., the UE 102) while a radio resource control connection between the UE and the base station is not active. At block 1002, the base station performs early data communication with the UE, similar to block 902 (e.g., events 304, 306, 380, 382, 383, 303, 324, 305, 320, 307, 310). At block 1004, the base station determines to stop the early data communication. At block 1006, the base station determines whether the determination made at block 1004 was made in response to detecting a failure associated with the early data communication. If so, then at block 1008, in response to the determination at block 1004, the base station transmits, to the UE, a command to reject the radio resource control connection (e.g., events 314, 390). Otherwise, then the base station transmits, to the UE, a command to release the radio resource control connection at block 1010.

In some implementations, the base station can (determine to) transmit a RRC setup message to the UE instead of the RRC reject message if the base station determines that the determination to stop the early data communication was made in response to detecting a failure. In yet other implementations, the base station can (determine to) transmit the RRC reject message if the base station determines that the determination to stop the early data communication was made in response to detecting a first-type failure, and the base station can (determine to) transmit the RRC setup message if the base station determines that the determination to stop the early data communication was made in response to detecting a second-type failure (as described above with reference to FIG. 7).

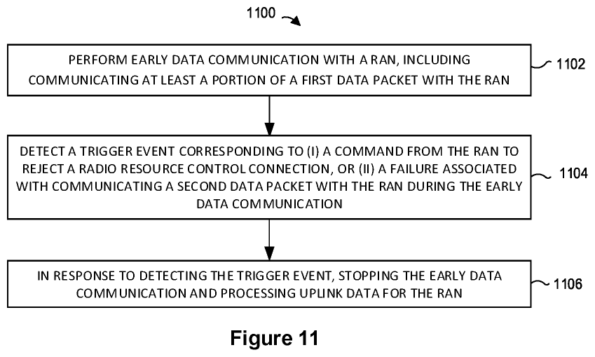

FIG. 11 is a flow diagram of an example method that can be implemented in a UE (e.g., the UE 102) for handling communication errors when communicating with a RAN (e.g., the RAN 105) while a radio resource control connection between the UE and the RAN is not active. At block 1102, the UE performs early data communication with the RAN, including communicating at least a portion of a first data packet with the RAN (e.g., events 304, 380, 303, 324, 382, 320, 383, 310). At block 1104, the UE detects a trigger event corresponding to: (i) a command from the RAN to reject the radio resource control connection (e.g., events 316, 390), or (ii) a failure associated with communicating a second data packet with the RAN during the early data communication (e.g., a failure detected during subsequent early data communication) (e.g., events 313, 315). In response to detecting the trigger event, the UE at block 1106 stops the early data communication (e.g., event 318, 390, 360), and processes uplink (UL) data for the RAN.

As an example, if the trigger event corresponds to receiving the command to reject the radio resource control connection, the UE may determine that the RAN failed to receive an UL data packet that the UE transmitted a segment of during the early data communication (e.g., the first data packet). In response, processing the UL data may include retransmitting the UL data packet. As another example, if the trigger event corresponds to receiving the command to reject the radio resource control connection and the command includes a timer value (e.g., a barring timer value), then the UE may start a timer with the timer value and refrain from transmitting the UL data to the RAN until the timer value expires.

If the trigger event corresponds to detecting the failure, detecting the failure may include: detecting a security error associated with the second data packet, determining that a number of attempted transmissions of the second data packet during the early data communication exceeds a threshold, determining that a timer, at the UE, associated with the early data communication has expired, or determining that a condition of a radio link between the UE and the RAN is not suitable for early data communication. To determine that the condition is not suitable for early data communication, the UE may detect that a BLER is above a threshold for early data communication or that a signal measurement of the radio link is below a threshold for early data communication.

The UL data that the UE processes in response to the trigger event may be fresh data that the UE generates after stopping the early data communication, data the UE generated and did not transmit before detecting the trigger event, data that the UE attempted to transmit during the early data communication (e.g., the first data packet or the second data packet) that the UE only transmitted a segment of and/or did not receive an acknowledgement. To transmit the UL data the UE can initiate a second early data communication to transmit the UL data to the RAN without transitioning to a connected state associated with a protocol for controlling radio resources (e.g., RRC_CONNECTED). Alternatively, the UE can transition to the connected state to transmit the UL data (e.g., event 392, 394).

The following list of examples reflects a variety of the embodiments explicitly contemplated by the present disclosure:
Example 1. A method in a central unit (CU) of a distributed base station of a radio access network (RAN) for handling communication errors when communicating with a user equipment (UE) while a radio resource control connection between the UE and the distributed base station is not active, the method comprising: performing, by processing hardware of the CU, early data communication with the UE; determining, by the processing hardware, to stop the early data communication; and in response to the determining, transmitting, by the processing hardware to the UE via a distributed unit (DU) of the distributed base station, a message to instruct the UE to stop the early data communication, the message formatted in accordance with a protocol for controlling radio resources.
Example 2. The method of example 1, further comprising: detecting, by the one or more processors, a failure associated with the early data communication, wherein the CU determines to stop the early data communication in response to detecting the failure.
Example 3. The method of example 2, wherein detecting the failure includes: receiving a failure indication from the DU.
Example 4. The method of any one of examples 1-3, wherein transmitting the message includes: transmitting a command to reject the radio resource control connection.
Example 5. The method of any one of examples 1-3, wherein transmitting the message includes: transmitting a command to set up a new radio resource control connection.
Example 6. A method in a base station of a radio access network (RAN) for handling communication errors when communicating with a user equipment (UE) while a radio resource control connection between the UE and the base station is not active, the method comprising: performing, by processing hardware of the base station, early data communication with the UE; determining, by the processing hardware, to stop the early data communication; and in a first instance, if the determining is in response to detecting a failure associated with the early data communication, transmitting, by the processing hardware to the UE, a command to reject the radio resource control connection; in a second instance, if the determining is not in response to detecting the failure, transmitting, by the processing hardware to the UE, a command to release the radio resource control connection.
Example 7. The method of any one of the preceding examples, wherein performing the early data communication includes: initiating the early data communication in response to receiving, from the UE, (i) an indication that the UE is initiating early data communication, and (ii) an uplink data packet.
Example 8. The method of any one of the preceding examples, wherein performing the early data communication includes: initiating the early data communication in response to receiving, from the UE, an indication that the UE is initiating early data communication; and transmitting, to the UE, a downlink data packet.
Example 9. The method of example 7 or 8, wherein performing the early data communication includes: exchanging a plurality of data packets with the UE.
Example 10. The method of any one of examples 1, 2 or 6-8, wherein detecting the failure includes: detecting a security error.
Example 11. The method of any one of examples 1, 2 or 6-8, wherein detecting the failure includes: detecting that a block error rate (BLER) is above a threshold.
Example 12. The method of any one of examples 1, 2 or 6-8, wherein detecting the failure includes: determining that a number of attempted transmissions of a protocol data unit (PDU) to the UE during the early data communication exceeds a threshold.
Example 13. The method of any one of examples 1, 2 or 6-8, wherein detecting the failure includes: determining that a timer associated with the early data communication has expired.
Example 14. A network node of a radio access network (RAN) including processing hardware and configured to implement a method according to any one of the preceding examples.
Example 15. A method in a user equipment (UE) for handling communication errors when communicating with a radio access network (RAN) while a radio resource control connection between the UE and the RAN is not active, the method comprising: performing, by processing hardware of the UE, early data communication with the RAN, including communicating at least a portion of a first data packet with the RAN; detecting, by the processing hardware, a trigger event corresponding to: (i) a command from the RAN to reject the radio resource control connection; or (ii) a failure associated with communicating a second data packet with the RAN during the early data communication; in response to detecting the trigger event: stopping, by the processing hardware, the early data communication; and processing, by the processing hardware, uplink data for the RAN.
Example 16. The method of example 15, wherein: the trigger event corresponds to the command from the RAN to reject the radio resource control connection.
Example 17. The method of example 16, wherein: performing the early data communication includes transmitting, to the RAN, an indication that the UE is initiating early data communication and a segment of the first data packet; and processing the uplink data includes: determining that the RAN failed to receive the first data packet; and retransmitting the first packet to the RAN.
Example 18. The method of example 16 or 17, wherein processing the uplink data includes: refraining from transmitting the uplink data to the RAN until a timer value included in the command expires.
Example 19. The method of example 15, wherein: the trigger event corresponds to the failure.
Example 20. The method of example 19, wherein detecting the failure includes: detecting a security error associated with the second data packet.
Example 21. The method of example 19, wherein detecting the failure includes: determining that a number of attempted transmissions of the second data packet during the early data communication exceeds a threshold.
Example 22. The method of example 19, wherein detecting the failure includes: determining that a timer, at the UE, associated with the early data communication has expired.
Example 23. The method of example 19, wherein detecting the failure includes: determining that a condition of a radio link between the UE and the RAN is not suitable for early data communication.
Example 24. The method of example 23, wherein determining that the condition is not suitable for early data communication includes: detecting that a block error rate (BLER) is above a threshold.
Example 25. The method of example 23, wherein determining that the condition is not suitable for early data communication includes: determining that a signal measurement of the radio link is below a threshold.
Example 26. The method of any one of examples 15-25, wherein processing the uplink data includes initiating a second early data communication to transmit the uplink data without transitioning to a connected state associated with a protocol for controlling radio resource control resources.
Example 27. The method of any one of examples 15-25, wherein processing the uplink data includes transitioning to the connected state to transmit the uplink data.
Example 28. A user equipment (UE) including processing hardware and configured to implement a method according to any one of examples 15-27.

The following additional considerations apply to the foregoing discussion.

In some implementations, the UE includes the message or UL data described above in a PDCP PDU and transmits the PDCP PDU to the CU via the DU. For example, the message can be the RRC setup complete message, the NAS message, the security mode complete message, or the RRC reconfiguration complete message. Similarly, the CU includes the message or DL data described above in a PDCP PDU and transmits the PDCP PDU to the UE via the DU. For example, the message can be the security mode command message or the RRC reconfiguration message.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

What is claimed is:

1. A method in a central unit (CU) of a distributed base station of a radio access network (RAN) for handling communication errors when communicating with a user equipment (UE) while a radio resource control connection between the UE and the distributed base station is not active, the method comprising:
performing, by processing hardware of the CU, early data communication with the UE;
determining, by the processing hardware, to stop the early data communication; and
in response to the determining, transmitting, by the processing hardware to the UE via a distributed unit (DU) of the distributed base station, a message to instruct the UE to stop the early data communication, the message formatted in accordance with a protocol for controlling radio resources.

2. The method of claim 1, further comprising:
detecting, by the one or more processors, a failure associated with the early data communication,
wherein the CU determines to stop the early data communication in response to detecting the failure.

3. The method of claim 2, wherein detecting the failure includes:
receiving a failure indication from the DU.

4. The method of any one of claims 1-3, wherein transmitting the message includes:
transmitting a command to reject the radio resource control connection.

5. The method of any one of claims 1-3, wherein transmitting the message includes:
transmitting a command to set up a new radio resource control connection.

6. A method in a base station of a radio access network (RAN) for handling communication errors when communicating with a user equipment (UE) while a radio resource control connection between the UE and the base station is not active, the method comprising:
performing, by processing hardware of the base station, early data communication with the UE to communicate a first data packet with the UE;
performing, by the processing hardware of the base station, subsequent early data communication with the UE to communicate a second data packet with the UE;
detecting, by the processing hardware, a failure associated with the subsequent early data communication;
transmitting, by the processing hardware to the UE, in response to detecting the failure, a command to reject the radio resource control connection.

7. The method of any one of claim 2 or 6, wherein detecting the failure includes at least one of:
detecting a security error;
detecting that a block error rate (BLER) is above a threshold;
determining that a number of attempted transmissions of a protocol data unit (PDU) to the UE during the early data communication exceeds a threshold; or
determining that a timer associated with the early data communication has expired.

8. A network node of a radio access network (RAN) including processing hardware and configured to implement a method according to any one of the preceding claims.

9. A method in a user equipment (UE) for handling communication errors when communicating with a radio access network (RAN) while a radio resource control connection between the UE and the RAN is not active, the method comprising:
performing, by processing hardware of the UE operating in an inactive state associated with a protocol for controlling radio resources, early data communication with the RAN, including communicating at least a portion of a first data packet with the RAN;
receiving, by the processing hardware, a command from the RAN to reject the radio resource control connection;
in response to receiving the command:
stopping, by the processing hardware, the early data communication;
reestablishing, by the processing hardware, at least one radio link control (RLC) entity.

10. The method of claim 9, further comprising:
in response to receiving the command, suspending, by the processing hardware, at least one packet data convergence protocol (PDCP) entity.

11. The method of claim 9 or 10, further comprising:
in response to receiving the command, processing, by the processing hardware, uplink data for the RAN.

12. The method of claim 11, wherein:
performing the early data communication includes transmitting, to the RAN, an indication that the UE is initiating early data communication and a segment of the first data packet; and
processing the uplink data includes:
determining that the RAN failed to receive the first data packet; and
retransmitting the first packet to the RAN.

13. The method of claim 11 or 12, wherein processing, by the processing hardware, the uplink data includes:
refraining from transmitting the uplink data to the RAN until a timer value included in the command expires.

14. The method of any one of claims 11-13, wherein processing, by the processing hardware, the uplink data includes initiating a second early data communication to transmit the uplink data without transitioning to a connected state associated with the protocol for controlling radio resources.

15. The method of any one of claims 11-13, wherein processing, by the processing hardware, the uplink data includes transitioning to the connected state to transmit the uplink data.

16. A user equipment (UE) including processing hardware and configured to implement a method according to any one of claims 9-15.
